(19) United States
(12) Patent Application Publication
(10) Pub. No.: US 2020/0394665 A1
(43) Pub. Date: Dec. 17, 2020

(54) NEGATIVE EXAMPLE DEGREE CALCULATION APPARATUS, NEGATIVE EXAMPLE DEGREE CALCULATION METHOD, AND COMPUTER READABLE RECORDING MEDIUM

(71) Applicant: NEC CORPORATION, Tokyo (JP)

(72) Inventors: Koji ICHIKAWA, Tokyo (JP); Shinji NAKADAI, Tokyo (JP)

(73) Assignee: NEC CORPORATION, Tokyo (JP)

(21) Appl. No.: 16/968,352

(22) PCT Filed: Feb. 8, 2018
(86) PCT No.: PCT/JP2018/004441

§ 371 Date: Aug. 7, 2020

(51) Int. Cl. G06Q 30/02; G06F 17/18; G06F 17/16

(52) U.S. Cl. CPC G06Q 30/0202; G06F 17/16; G06F 17/18

(57) ABSTRACT

A negative example degree calculation apparatus 10 is provided with a purpose inference unit 11 that infers a purpose for which a user used an item in the past from relational data specifying the item used by the user in the past and purpose information indicating a use purpose of the item by the user, and a negative example degree computation unit 12 that computes a negative example degree indicating a possibility of the item not being selected by the user, based on the inferred purpose and the purpose information.

### TECHNICAL FIELD

The present invention relates to a negative example degree calculation apparatus and a negative example degree calculation method for computing negative example degrees that indicate the possibility of items not being selected by a user, and further relates to a computer readable recording medium that includes a program recorded thereon for realizing the apparatus and method.

### BACKGROUND ART

In recent years, consumer needs have become increasingly diversified. In pace with this, the types of products and content that consumers are able to purchase have also dramatically increased. In light of this background, systems (recommendation systems) that recommend products or content to consumers that match their tastes have been developed. Also, recommendation systems play a very important role in terms of improving the degree of consumer satisfaction in the purchase of products and provision of services.

In many recommendation systems, the preferences of consumers who serve as the users are predicted from service use data, and products or content that align with those preferences are recommended. For example, in the case where it is evident from service use data that a user often watches sci-fi movies, the recommendation system predicts that the user has a preference for science fiction and science. In this case, the recommendation system recommends sci-fi movies, science-related books and the like to the user. Improvements in purchase promotion and service satisfaction for users are thereby conceivably achieved.

Incidentally, with EC sites or video viewing sites that employ the above-mentioned recommendation system, in most cases, the user selects only items that he or she likes and purchases or views the selected items. Thus, in many cases, data indicating things that the user “does not like and has shunned” (hereinafter, “negative examples”) are not held by the system. It is, however, thought that if recommendation systems were able to hold data indicating such negative examples, the recommendation systems would be able to recommend products and content that satisfy users with greater accuracy. In recent years, technologies that infer negative examples for users have thus also been proposed (e.g., refer to Non-Patent Document 1).

Specifically, Non-Patent Document 1 discloses a system that computes negative example degrees. The system disclosed in Non-Patent Document 1 models a range of items that the user “is aware of” (hereinafter this range will be referred to as a “visual field”), and assigns a high negative example degree to items that were not selected among the items within the visual field.

The “negative example degree” is a numerical value indicating the degree of correspondence to a negative example, that is, indicates the possibility of an item not being selected by a user. In other words, a certain item having a high negative example degree for a certain user means that the user has a strong aversion to that item. In this case, the negative example degree is represented by a discrete value or a real number. Also, in the system disclosed in Non-Patent Document 1, the visual field model is constructed based on the fame of the items themselves or information on users (location, occupation, etc.).

Here, the configuration of the system disclosed in Non-Patent Document 1 will be described using FIG. 17. FIG. 17 is a block diagram showing the configuration of the system disclosed in Non-Patent Document 1.

As shown in FIG. 17, a system 200 disclosed in Non-Patent Document 1 is provided with a visual field inference unit 201, a relational information prediction unit 202, and a used item database 203. Of these constituent elements, the used item database 203 registers, for every user, information on items used by the user in the past (hereinafter, “relational data”). Note that database will henceforth be written as “DB”.

The visual field inference unit 201 infers the visual field of each user, such as items that the user has an awareness of, for example, and creates a visual field model for inferring the visual field of the user. Also, Non-Patent Document 1 discloses two techniques for inference of the visual field by the visual field inference unit 201.

The first technique involves inferring the visual field, based on the popularity rating of each item. Specifically, the first technique envisages that items with a high popularity rating will tend to enter the visual field of all users. The second technique involves inferring the visual field, based on the personal information of users, such as the occupation or location of users. Specifically, it is envisaged, for example, that particularly restaurants in the area will tend to enter the visual field of users residing in a certain place. The visual field inference unit 201 uses parameters to model the visual field of each user inferred using these techniques to create a visual field model.

Also, the relational information prediction unit 202 respectively infers latent information of users and items from the visual field model created by the visual field inference unit 201 and the relational data that is registered in the used item DB 203. The relational information prediction unit 202 then represents the respective latent information of the users and items with a vector, and evaluates the preference of each user with respect to each item with a numerical value using a function of these two vectors.

Also, at this time, the relational information prediction unit 202 infers that the user likes items that he or she has used (henceforth, positive examples), and evaluates the user's preference for these items with a high value. On the other hand, the relational information prediction unit 202 infers that items that the user has not used among items that are within his or her visual field are negative examples, and evaluates the user's preference for these items with a low value. Note that the value given to negative examples correspond to the above-mentioned “negative example degree”.

Here, operations at the time of creation of a visual field model by the recommendation system shown in FIG. 17 will be described using FIG. 18. FIG. 18 is a flow diagram showing operations at the time of visual field model creation by the recommendation system shown in FIG. 17.

As shown in FIG. 18, initially, the visual field inference unit 201 infers, for every user, a visual field using the initial values of parameters, and sets a visual field model (step S100).

Next, the relational information prediction unit 202 respectively infers the latent information of users and items from the visual field models of the users modeled in step S100 and the relational data for learning of the users, and converts the preference of users for each item into a numerical value, using the inferred latent information (step S200).

Next, the relational information prediction unit 202 determines whether the result obtained in step S200 satisfies an end condition; specifically, whether a set accuracy has been reached (step S300). If the result of the determination of step S300 indicates that the end condition is satisfied, the relational information prediction unit 202 ends the processing.

On the other hand, if the result of the determination of step S300 indicates that the end condition is not satisfied, the relational information prediction unit 202 computes a correction amount for correcting the parameters of the visual field model (step S400). Specifically, the relational information prediction unit 202 derives the difference between the numerical value obtained in step S200 and the numerical value that is assigned to the relational data for learning (numerical value representing a positive example or a negative example), and computes a correction amount from the derived difference.

After the execution of step S400, step S100 is executed again. In this case, in step S100, the visual field inference unit 201 corrects the parameters with the correction amount computed in step S400, and sets the visual field model. Thereafter, steps S200 and S300 are executed, and if the end condition is not satisfied, step S400 is executed again.

In this way, a highly accurate visual field model is created by steps S100 to S400 being repeatedly executed.

### LIST OF RELATED ART DOCUMENTS

### Non-Patent Document

Non-Patent Document 1: “Modeling User Exposure in Recommendation”, Dawen Liang, Laurent Charlin, James McInerney, David M. Blei, Proceedings of the 25th International Conference on World Wide Web (WWW), 2016.

### SUMMARY OF INVENTION

### Problems to be Solved by the Invention

In this way, the system disclosed in Non-Patent Document 1 is also able to infer negative examples of users in addition to positive examples, and compute negative example degrees. However, with the system disclosed in Non-Patent Document 1, the visual field is set using the popularity rating of items or the personal information of users, and the visual field is fixed after being set, and thus negative examples are inferred in a forced manner. Moreover, users normally compare products aligned with the “purpose for purchasing”, and thus the visual field also conceivably changes depending on the situation, but the visual field is fixed as mentioned above. There is thus a problem with the system disclosed in Non-Patent Document 1 in that negative example degrees cannot be accurately computed.

An example object of the invention is to provide a negative example degree calculation apparatus, a negative example calculation method and a computer readable recording medium that can achieve an improvement in the computational accuracy of the negative example degrees of items.

### Means for Solving the Problems

A negative example degree calculation apparatus according to an example aspect of the invention includes:

a purpose inference unit configured to infer a purpose for which a user used an item in the past from relational data specifying the item used by the user in the past and purpose information indicating a use purpose of the item by the user; and

a negative example degree computation unit configured to compute a negative example degree indicating a possibility of the item not being selected by the user, based on the inferred purpose and the purpose information.

Also, a negative example degree calculation method according to an example aspect of the invention includes:

(a) a step of inferring a purpose for which a user used an item in the past from relational data specifying the item used by the user in the past and purpose information indicating a use purpose of the item by the user; and

(b) a step of computing a negative example degree indicating a possibility of the item not being selected by the user, based on the inferred purpose and the purpose information.

Furthermore, a computer readable recording medium according to an example aspect of the invention includes a program recorded thereon, the program including instructions that cause a computer to carry out:

(a) a step of inferring a purpose for which a user used an item in the past from relational data specifying the item used by the user in the past and purpose information indicating a use purpose of the item by the user; and

(b) a step of computing a negative example degree indicating a possibility of the item not being selected by the user, based on the inferred purpose and the purpose information.

### Advantageous Effects of the Invention

As described above, according to the invention, an improvement in the computational accuracy of the negative example degrees of items can be achieved.

### BRIEF DESCRIPTION OF THE DRAWINGS

FIG. 1 is a block diagram showing a schematic configuration of a negative example degree calculation apparatus in a first example embodiment of the invention.

FIG. 2 is a block diagram showing a specific configuration of the negative example degree calculation apparatus in the first example embodiment of the invention.

FIG. 3 is a flow diagram showing operations of the negative example degree calculation apparatus in the first example embodiment of the invention.

FIG. 4 is a block diagram showing a specific configuration of the negative example degree calculation apparatus in a second example embodiment of the invention.

FIG. 5 is a flow diagram showing operations of the negative example degree calculation apparatus in the second example embodiment of the invention.

FIG. 6 is a flow diagram showing operations of a first variation of the negative example degree calculation apparatus in the second example embodiment of the invention.

FIG. 7 is a diagram showing the configuration of a second variation of the negative example degree calculation apparatus in the second example embodiment of the invention.

FIG. 8 is a block diagram showing a specific configuration of the negative example degree calculation apparatus in a third example embodiment of the invention.

FIG. 9 is a flow diagram showing operations of the negative example degree calculation apparatus in the third example embodiment of the invention.

FIG. 10 is a block diagram showing a specific configuration of the negative example degree calculation apparatus in a fourth example embodiment of the invention.

FIG. 11 is a flow diagram showing operations of the negative example degree calculation apparatus in the fourth example embodiment of the invention.

FIG. 12 is a block diagram showing a specific configuration of the negative example degree calculation apparatus in a fifth example embodiment of the invention.

FIG. 13 is a flow diagram showing operations of the negative example degree calculation apparatus in the fifth example embodiment of the invention.

FIG. 14 is a block diagram showing a specific configuration of the negative example degree calculation apparatus in a sixth example embodiment of the invention.

FIG. 15 is a flow diagram showing operations of the negative example degree calculation apparatus in the sixth example embodiment of the invention.

FIG. 16 is a block diagram showing an example of a computer that realizes the negative example degree calculation apparatus in the first to sixth embodiments of the invention.

FIG. 17 is a block diagram showing the configuration of a system disclosed in Non-Patent Document 1.

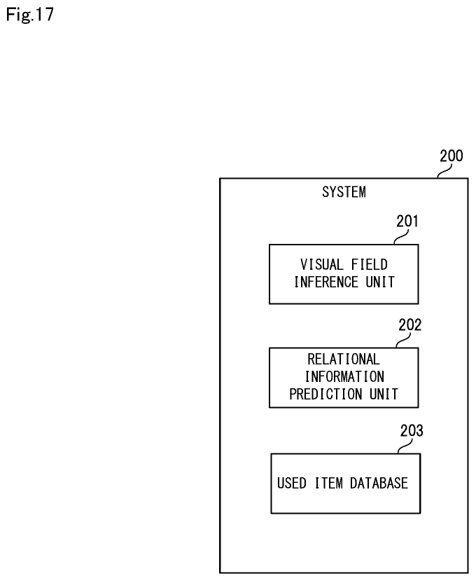

FIG. 18 is a flow diagram showing operations at the time of visual field model creation by the recommendation system shown in FIG. 17.

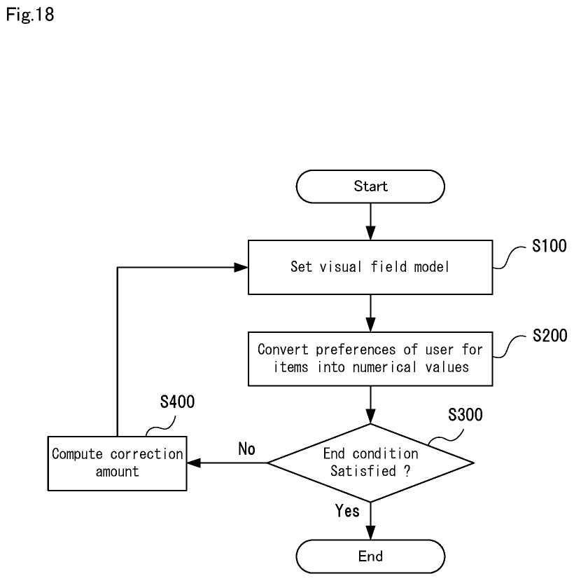

### EXAMPLE EMBODIMENTS

### First Example Embodiment

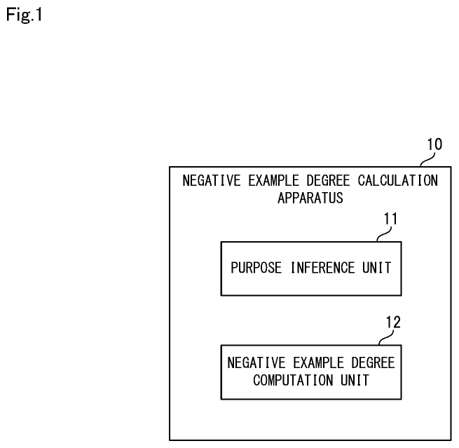

Hereinafter, a negative example degree calculation apparatus, a negative example degree calculation method and a program in a first example embodiment of the invention will be described with reference to FIGS. 1 to 3.

[Apparatus Configuration]

Initially, the configuration of the negative example degree calculation apparatus in the first example embodiment will be described using FIG. 1. FIG. 1 is a block diagram showing a schematic configuration of the negative example degree calculation apparatus in the first example embodiment of the invention.

A negative example degree calculation apparatus 10 in the first example embodiment, shown in FIG. 1, is an apparatus that calculates negative example degrees of items that are sold on websites, such as products or content, for example. A negative example degree is an index indicating the possibility of an item not being selected by a user.

As shown in FIG. 1, the negative example degree calculation apparatus 10 is provided with a purpose inference unit 11 and a negative example degree computation unit 12. The purpose inference unit 11 infers the purpose for which users used items in the past from relational data and purpose information. Relational data is data specifying items that users used in the past. Purpose information is information indicating the purpose for which users used items.

The negative example degree computation unit 12 computes negative example degrees that indicate the possibility of items not being selected by users, based on the above purpose inferred by the purpose inference unit 11 and the purpose information.

In this way, in the first example embodiment, the purpose for which users used items in the past is inferred by the purpose inference unit 11, thus enabling specification of items that are aligned with the purpose of the user but will not be selected by the user. Such items are considered to be true negative examples, and thus, according to the first example embodiment, an improvement in the computational accuracy of the negative example degrees of items will be achieved.

In the first example embodiment, “items” are products, content or the like that are provided to users. Specifically, items include products that are sold in physical stores or on EC (Electronic Commerce) sites, video content that is provided by video viewing services on websites, and webpages on websites. Furthermore, in the first example embodiment, “use of items by users” includes, for example, purchasing of products by users in physical stores or on EC sites, viewing of video content by users, and accessing of websites by users.

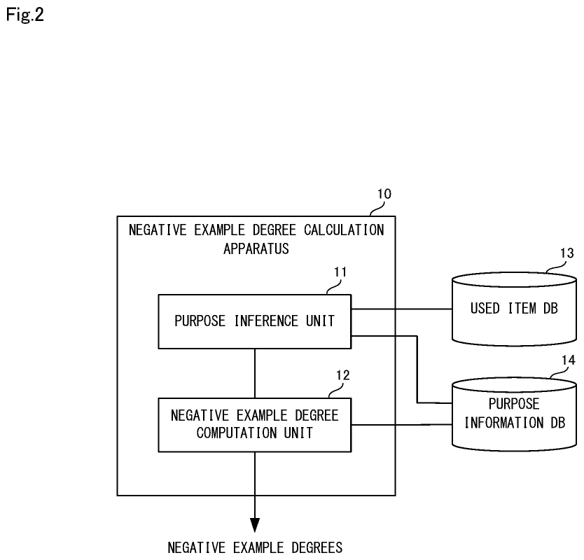

Here, the configuration of the negative example degree calculation apparatus in the first example embodiment will be more specifically described using FIG. 2. FIG. 2 is a block diagram showing a specific configuration of the negative example degree calculation apparatus in the first example embodiment of the invention.

As shown in FIG. 2, in the first example embodiment, the negative example degree calculation apparatus 10 is connected to a used item database (DB) 13 that stores relational data and a purpose information database (DB) 14 that stores purpose information. Note that, in the example of FIG. 2, the used item DB 13 and the purpose information DB 14 are provided externally to the negative example degree calculation apparatus 10, but may be provided internally to the negative example degree calculation apparatus 10.

The used item DB 13 stores the above-mentioned relational data. Relational data, in the first example embodiment, is data specifying, for every user, which items the user used and when. Specific examples of relational data include the viewing history of video content viewed by the user, the purchase history of items purchased by the user on EC sites, and, further, the history of places visited by the user in geosocial networking services.

The purpose information DB 14 stores the above-mentioned purpose information. The purpose information, in the first example embodiment, is set for every item, and is information for inferring the purpose for which users use the item. Also, the purpose information, in the first example embodiment, is stored in the purpose information DB 14 in the form of a tag, a vector, a matrix or a tensor.

Also, the purpose information may be constituted, for every item, by a plurality of types of information. Furthermore, the purpose information may be set for each item, for every user or every time that the item is used (refer to later description). In addition, the purpose information may include an attribute of the item, such as information representing the genre or nature of the item, for example.

Furthermore, the purpose information is set based on the type of item. For example, assuming the item is health food, “for health” is given as the purpose for which the user purchases the item, and thus the tag “for health” is assigned to the purpose information. Also, assuming the item is a zero calorie drink, “for health”, “want something sweet”, “want something to drink”, or a combination thereof are given as the purpose for which the user purchases the item, and are thus assigned as tags to the purpose information.

Also, the purpose information is defined by a vector whose components are a plurality of purposes, for example. Taking the above-mentioned health food as an example, a vector in which “for health” and another purpose (e.g., “want something to eat”) are respectively set to 1 and 0 is defined. Also, in the case of using a vector as purpose information, the value of the components is not limited to 1 or 0, and may be any weighted value. Specifically, an example is given in which, in a vector having the three components “for health”, “want something sweet” and “want something to drink”, the values of the components are respectively set to “0.6”, “1.4” and “1.0”.

Also, for example, in the case where the item is a reference book, the purpose for purchasing the reference book may be “for taking an exam” for a certain student, whereas the purpose will be “for learning” for a person of certain age group or occupation. Accordingly, the purpose information may be defined according to an attribute of users. In such a case, the purpose information is defined by a matrix whose rows are users and columns are purpose items, and a matrix is assigned for every item.

Also, the purpose information may be set according to the time at which or the period in which the item is used. For example, the purpose for visiting a certain mountain is “for mountain climbing” in summer, “for seeing the autumn colors” in autumn, and “for winter sports” in winter. That is, the purpose changes depending on the period. Accordingly, such elements may be added to the abovementioned matrix. In this case, the purpose information will be in a form of a tertiary tensor assigned to each item.

The purpose inference unit 11, in the first example embodiment, acquires relational data from the used item DB 13, and acquires purpose information from the purpose information DB 14. The purpose inference unit 11 then infers, for every user, what the purpose of the user was when he or she purchased each item, based on the purpose information of the purchased item.

For example, assume that the purpose information is provided by one tag or one vector every purchase of an item. In this case, the purpose inference unit 11 is able to infer the purpose that is represented with one tag or one vector as the purpose of the user. Also, assume that the purpose information is provided by a plurality of tags or a plurality of vectors every purchase of an item. In this case, the purpose inference unit 11 is, for example, able to specify, from the plurality of tags, a union of categories, a distribution of categories, or a most frequent category that appears most frequently, and infer the purpose of the user from the specified result. Also, the purpose inference unit 11 is also able to derive, from the plurality of vectors, the sum thereof, the average thereof or the like, and infer the purpose of the user from the derived numerical value.

Also, assume, for example, that a history of a zero calorie drink that a certain user has purchased has been recorded in the relational data. Furthermore, assume that the purpose information for that zero calorie drink is a vector in which 1 is assigned to the purpose items “for health”, “want something sweet” and “want something to drink”, and 0 is assigned to other purpose items. In this case, the purpose inference unit 11 is able to output, as the purpose for which this user purchased the zero calorie drink, a vector in which the purpose items “for health”, “want something sweet” and “want something to drink” are assigned 1 and other purpose items are assigned 0, for example.

The negative example degree computation unit 12, in the first example embodiment, first acquires the purpose with respect to each item for every user inferred by the purpose inference unit 11, and the purpose information of each item that is stored in the purpose information DB 14. The negative example degree computation unit 12 then assigns a large negative example degree to items that were not selected among items having purpose information close to the purpose of the user.

Here, an example of a technique for calculating the negative example degree will be described. Also, hereinafter, it is assumed that the negative example degree is computed for an item other than a specific item. In this case, the purpose inference unit 11 uses purpose information indicating the use purpose of the specific item by the user, and the negative example degree computation unit 12 computes a negative example degree, based on the inferred purpose and purpose information indicating the use purpose of the other item.

For example, assume that the items are movies that are provided by video viewing sites. In this case, the purpose inference unit 11 infers that the purpose of a user who watched a certain action movie A was “for watching action”, and outputs vector U in which the corresponding purpose item is set to “1”, another purpose item such as “for watching actor B's performance” is set to “0.1”, and the remaining purpose items are set to “0”.

Also, assume that the other items are a movie C which is an action movie in which actor B does not appear, a movie D which is comedy starring actor B, and a movie E which is a sci-fi movie with some light action elements in which actor B appears in a supporting role.

Assume that, as purpose information for these items, a vector V1 in which “for watching action” is “1” and “for watching actor B's performance” is “0” is provided for movie C. Assume that a vector V2 in which “for watching action” is “0” and “for watching actor B's performance” is “1” is provided for movie D. Assume that a vector V3 in which “for watching action” is “0.3” and “for watching actor B's performance” is “0.5” is provided for movie E. Note that, in the following description, vectors provided as purpose information will be described as “vector V” in the case of not identifying the specific vectors.

In such cases, the negative example degree can, for example, be defined by the inner product of vector U indicating the purpose of the user inferred by the purpose inference unit 11 and vector V which is the purpose information. Accordingly, the negative example degree computation unit 12 computes, as negative example degrees, U·V1=1 for movie C, U·V2=0.1 for movie D, and U·V3=0.35 for movie E.

Accordingly, a user who wants to watch a movie with the main purpose of “for watching action” and with a slight desire to watch the performance of actor B this time intuitively selects movie A, despite movie A and movie C both being action movies. Thus, it can be surmised that movie C was not selected by the user despite the purpose being met, and a high negative example degree (1 in this example) is given.

On the other hand, movie D is taken as having not being actively selected since the main purpose of viewing this time (watching an action movie) is not met regardless of the user's likes and dislikes, and the negative example degree that is assigned will be low (here 0.1). A moderately negative example degree (here 0.35) is calculated for the intermediately placed sci-fi movie E that contains some action.

[Apparatus Operations]

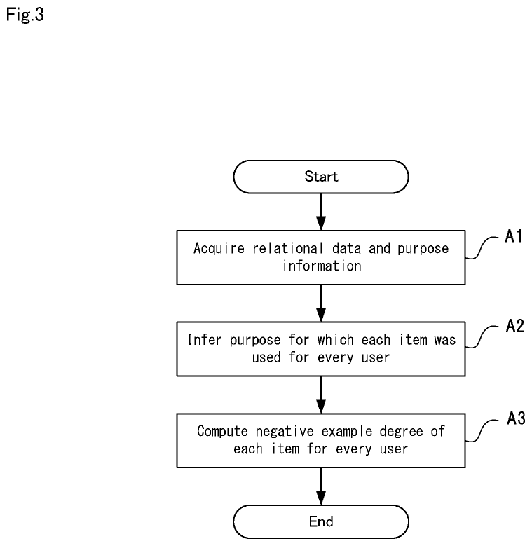

Next, the operations of the negative example degree calculation apparatus 10 in the first example embodiment of the invention will be described using FIG. 3. FIG. 3 is a flow diagram showing operations of the negative example degree calculation apparatus in the first example embodiment of the invention. In the following description, FIGS. 1 and 2 will be taken into consideration as appropriate. Also, in the first example embodiment, the negative example degree calculation method is implemented by operating the negative example degree calculation apparatus 10. Therefore, the following description of the operations of the negative example degree calculation apparatus 10 will be given in place of a description of the negative example degree calculation method in the first example embodiment.

As shown in FIG. 3, initially, the purpose inference unit 11 acquires relational data from the used item DB 13, and acquires purpose information from the purpose information DB 14 (step A1). Next, the purpose inference unit 11 infers, for every user, what the purpose of the user was when he or she used each item, based on the purpose information of the purchased item (step A2).

When step A2 is executed, the negative example degree computation unit 12, first, acquires the purpose with respect to each item for every user inferred in step A2, and the purpose information of each item that is stored in the purpose information DB 14. The negative example degree computation unit 12 then computes, for every user, the negative example degree of each item, such that items that were not selected, among items having purpose information close to the purpose of the user, are assigned a large negative example degree (step A3).

The processing in the negative example degree calculation apparatus 10 provisionally ends after execution of step A3. The negative example degrees computed in step A3 are, for example, used in a recommendation system that recommends products or content to users. Note that illustration of the recommendation system has been omitted in FIGS. 1 and 2.

### Effects of First Embodiment

As described above, in the first example embodiment, the purpose of a user is inferred, and thus a high negative example degree will be assigned to items that are aligned with the purpose of the user but are not selected by the user. Thus, according to the first example embodiment, it becomes possible to compute negative example degrees with high accuracy, compared with conventional technologies that do not take into consideration the purpose for which users used items.

Also, if the negative example degrees obtained by the first example embodiment are applied in a recommendation system, the processing time taken for recommendation in the recommendation system can be shortened. This is because, although a conventional recommendation system is required to determine, for all items, whether the items should be recommended to the user or not, use of the negative example degrees computed by the first example embodiment enables items that should be not recommended to be uniformly specified from the values thereof

[Program]

A program in the first example embodiment need only be a program that causes a computer to execute steps A1 to A3 shown in FIG. 3. The negative example degree calculation apparatus 10 and the negative example degree calculation method in the first example embodiment can be realized, by this program being installed on a computer and executed. In this case, a processor of the computer performs processing while functioning as the purpose inference unit 11 and the negative example degree computation unit 12.

Also, in the first example embodiment, the used item DB 13 and the purpose information DB 14 can be realized by storing data files constituting these databases in a storage device such as a hard disk provided in the computer. Also, in this case, the computer may be a computer on which the program of the first example embodiment is installed, or may be another computer connected to such a computer.

Also, the program in the first example embodiment may be executed by a computer system built from a plurality of computers. In this case, for example, the computers may respectively function as one of the purpose inference unit 11 and the negative example degree computation unit 12.

### Second Example Embodiment

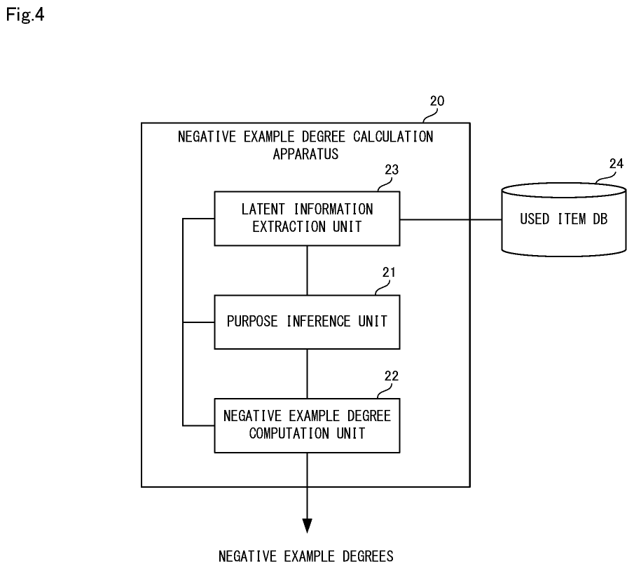

Next, a negative example degree calculation apparatus, a negative example degree calculation method and a program in a second example embodiment of the invention will be described, with reference to FIGS. 4 to 6.

[Apparatus Configuration]

Initially, the configuration of the negative example degree calculation apparatus in the second example embodiment will be described using FIG. 4. FIG. 4 is a block diagram showing a specific configuration of the negative example degree calculation apparatus in the second example embodiment of the invention.

As shown in FIG. 4, a negative example degree calculation apparatus 20 in the second example embodiment differs from the negative example degree calculation apparatus 10 in the first example embodiment shown in FIGS. 1 and 2, in terms of being provided with a latent information extraction unit 23, and not using a relational information DB (refer to FIG. 2). Hereinafter, the description will focus on the differences from the first example embodiment.

As shown in FIG. 4, the negative example degree calculation apparatus 20 in the second example embodiment is provided with a purpose inference unit 21, a negative example degree computation unit 22, and a latent information extraction unit 23. Also, the negative example degree calculation apparatus 20 is connected to a used item DB 24. Note that the used item DB 24 is similar to the used item DB 13 shown in FIGS. 1 and 2, and stores relational data.

The latent information extraction unit 23 generates a matrix specifying items used by users from the users and items that are included in the relational data, and, further, derives vectors representing the preferences of users and vectors representing the latent attributes of items from the generated matrix, and extracts latent information from the derived vectors.

Specifically, the latent information extraction unit 23 acquires relational data from the used item DB 24, and extracts the latent information of each item, by applying a technique that uses singular value analysis, a technique that uses a probabilistic block model, a technique that uses a latent feature model or the like to the acquired relational data. The latent information extraction unit 23 then outputs the extracted latent information of each item in the form of a scalar, a vector or a tensor.

The case where the relational data is a viewing history of movies (video content) viewed by each user on video viewing sites, and the latent information extraction unit 23 extracts latent information using singular value analysis on the viewing histories of the users will be described as an example.

Specifically, the latent information extraction unit 23, first, generates matrix Y whose rows are users and columns are viewed movies for the viewing histories of users serving as relational data. This matrix Y is a matrix of M rows and N columns, where M is the total number of users, and N is the total number of movies.

The matrix element of the uth row and ith column being “1” in matrix Y means that user u has viewed movie i. This matrix Y will, hereinafter, be represented as an “adjacency matrix” of relational data. Also, in this example, all elements that have not been viewed are set to “0”. Low-rank approximation of matrix Y is obtained in the form of matrix multiplication when the latent information extraction unit 23 executes singular value analysis on matrix Y.

Specifically, first, when matrix Y is a matrix of M rows and N columns, a suitable integer D that is sufficiently smaller than M and N is determined. Then, assuming matrix P of M rows and D columns and matrix Q of N rows and D columns, the latent information extraction unit 23 calculates matrices P and Q that satisfy “Y≅P·Q′”. Here, “Q′” indicates a transposed matrix of matrix Q. The rows p of matrix P obtained here can be regarded as vectors representing the preference of respective users, and the rows q of matrix Q can be regarded as vectors representing the latent attribute of respective movies. In this case, the latent information extraction unit 23 is able to extract vector q as the latent information of an item, and output this vector.

The purpose inference unit 21, in the second example embodiment, differs from the first example embodiment in using latent information instead of relational data and purpose information to infer the purpose for which users used items in the past. Specifically, as described above, it is assumed that vector q of each item has been extracted and output as latent information by the latent information extraction unit 23. In this case, the purpose inference unit 21, when a certain user used a certain item i, for example, infers vector (hereinafter, “latent information vector”) qi which is the latent information of item i as the purpose of the user, and outputs this vector.

Also, the negative example degree computation unit 22, in the second example embodiment, differs from the first example embodiment in using latent information instead of purpose information to compute the negative example degrees. In other words, in the second example embodiment, the negative example degree computation unit 22 computes a negative example degree for each item for every user from the purpose of the user inferred by the purpose inference unit 21 and the latent information extracted by the latent information extraction unit 23.

Specifically, it is assumed that vector q has been extracted by the latent information extraction unit 23 as the latent information of each item, and latent information vector qi of a certain item i has been inferred by the purpose inference unit 21 as the purpose for which a certain user used item i.

In this case, the negative example degree computation unit 22 is, for example, able to calculate the negative example degree using the cosine of purpose information vector qi of item i and latent information vector qj of item j (j is not i), namely, cos θ(qi, qj)=qi·qj/(|qi∥qj|). That is, a negative example degree z can be defined for each item j as 1+cos θ(qi, qj). In the case of computing the negative example degree in this manner, it is assumed that item j having latent information close to item i has purpose information similar to item i. Accordingly, assuming that item j is not selected, the negative example degree computation unit 22 computes a negative example degree for item j, so as to give a larger negative example degree.

[Apparatus Operations]

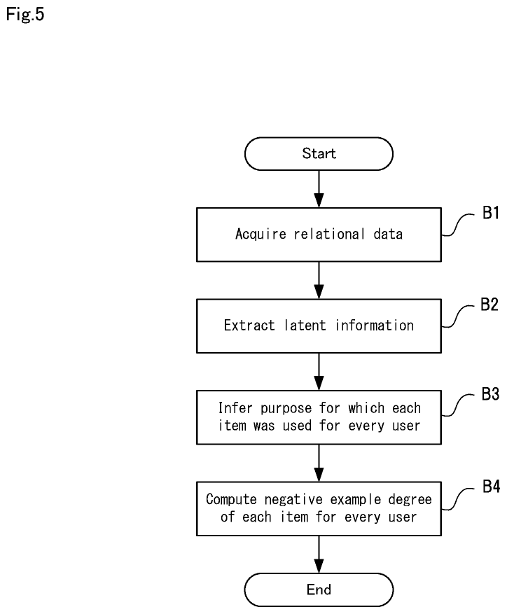

Next, operations of the negative example degree calculation apparatus 20 in the second example embodiment of the invention will be described using FIG. 5. FIG. 5 is a flow diagram showing operations of the negative example degree calculation apparatus in the second example embodiment of the invention. In the following description, FIG. 3 is taken into consideration as appropriate. Also, in the second example embodiment, the negative example degree calculation method is implemented by operating the negative example degree calculation apparatus 20. Therefore, the following description of the operations of the negative example degree calculation apparatus 20 will be given in place of a description of the negative example degree calculation method in the second example embodiment.

As shown in FIG. 5, initially, the latent information extraction unit 23 acquires relational data from the used item DB 24 (step B1).

Next, the latent information extraction unit 23 generates a matrix specifying items that users have used from the users and items that are included in the relational data acquired in step B1. The latent information extraction unit 23 then derives vectors representing the preference of users and vectors representing the latent attribute of items from the generated matrix, and extracts latent information from the derived vectors (step B2).

Next, the purpose inference unit 21 infers the purpose for which users used items in the past, using the latent information extracted in step B2 (step B3). Next, the negative example degree computation unit 22 computes, for every user, the negative example degree of each item, using the purpose inferred in step B3 and the latent information extracted in step B2 (step B4).

The processing in the negative example degree calculation apparatus 20 provisionally ends after execution of step B4. The negative example degrees computed in step B4 are, for example, used in a recommendation system that recommends products or content. Note that illustration of the recommendation system has been omitted in FIG. 4.

### Effects of Second Embodiment

As described above, in the second example embodiment, latent information is used instead of the purpose information that is used in the first example embodiment. Vectors representing the latent attribute of respective items, for example, are used as latent information. In the second example embodiment, a high negative example degree will thus similarly be assigned to items that are aligned with the purpose of the user but are not selected by the user. Thus, in the second example embodiment, similarly to the first example embodiment, it becomes possible to compute negative example degrees with high accuracy, compared with conventional technologies that do not take into consideration the purpose for which users used items.

Also, in the case where the negative example degrees obtained by the second example embodiment are applied in a recommendation system, the processing time taken for recommendation in the recommendation system can be shortened, similarly to the first example embodiment.

[Program]

A program in the second example embodiment need only be a program that causes a computer to execute steps B1 to B4 shown in FIG. 5. The negative example degree calculation apparatus 20 and the negative example degree calculation method in the second example embodiment can be realized, by this program being installed on a computer and executed. In this case, a processor of the computer performs processing while functioning as the purpose inference unit 21, the negative example degree computation unit 22, and the latent information extraction unit 23.

Also, in the second example embodiment, the used item DB 24 can be realized by storing data files constituting this database in a storage device such as a hard disk provided in the computer. Also, in this case, the computer may be a computer on which the program of the second example embodiment is installed, or may be another computer connected to this computer.

Also, the program in the second example embodiment may be executed by a computer system built from a plurality of computers. In this case, for example, the computers may respectively function as one of the purpose inference unit 21, the negative example degree computation unit 22, and the latent information extraction unit 23.

[First Variation]

Here, a first variation of the negative example degree calculation apparatus, the negative example degree calculation method and the program in the second example embodiment will be described.

First, in the first variation, the negative example degree computation unit 22 is configured so as to input the computed negative example degrees to the latent information extraction unit 23. The latent information extraction unit 23, after having generated a matrix, thus updates the matrix using the negative example degrees computed by the negative example degree computation unit 22, and further extracts new latent information from the updated matrix. The purpose inference unit 21 then infers the purpose again using the new latent information, and the negative example degree computation unit 22 computes the negative example degrees again using the new latent information.

Specifically, first, in the above-mentioned example, the latent information extraction unit 23 sets all elements corresponding to items that have not been viewed to “0”, when generating a matrix from the viewing histories of users serving as relational data. This is equivalent to approximating that the users do not like all movies that they have not viewed.

In contrast, in the first variation, the latent information extraction unit 23 extracts latent information, using negative example degrees that were previously computed. In this case, the latent information extraction unit 23, in generating a matrix, sets corresponding elements to “0” or a value close thereto, with respect to only movies (items) judged to have a high negative example degree for each user, for example. Also, the latent information extraction unit 23, in generating a matrix, sets corresponding elements to “0.5”, with respect to other movies that have not been viewed. More specifically, the latent information extraction unit 23 is able to set the uth row and ith column of matrix Y to 1-z, assuming that a negative example degree z taking a value from 0 to 1 (a larger value indicating a higher negative example degree) is given to user u and item i.

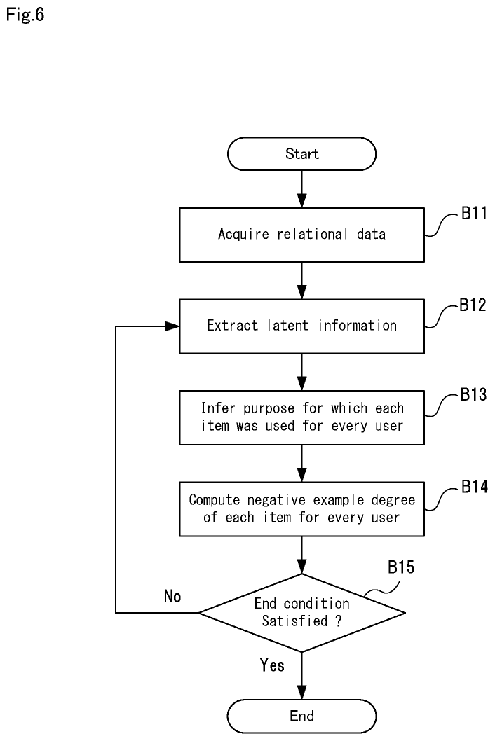

Next, operations of the negative example degree calculation apparatus in the first variation will be described using FIG. 6. FIG. 6 is a flow diagram showing operations of the first variation of the negative example degree calculation apparatus in the second example embodiment of the invention.

As shown in FIG. 6, initially, the latent information extraction unit 23 acquires relational data from the used item DB 24 (step B11). Step B11 is similar to step B1 shown in FIG. 5.

Next, the latent information extraction unit 23 generates a matrix specifying items used by users from users and items that are included in the relational data acquired in step B11. The latent information extraction unit 23 then derives vectors representing the preference of users and vectors representing the latent attribute of items from the generated matrix, and extracts latent information from the derived vectors (step B12). Step B12 is similar to step B1 shown in FIG. 5.

Next, the purpose inference unit 21 infers the purpose for which users used items in the past, using the latent information extracted in step B12 (step B13). Step B13 is similar to step B3 shown in FIG. 5.

Next, the negative example degree computation unit 22 computes, for every user, the negative example degree of each item, using the purpose inferred in step B13 and the latent information extracted in step B12 (step B14). Step B14 is similar to step B4 shown in FIG. 5.

Next, the negative example degree computation unit 22 determines whether an end condition has been satisfied (step B15). Specifically, the negative example degree computation unit 22 computes the difference between the negative example degree computed in step B14 and the negative example degree (initial value in the case where step B15 is executed for the first time) computed in the previous step B14, and determines whether the computed difference is within a set range.

If the result of the determination of step B15 indicates that the end condition has been satisfied (if the computed difference is within the set range), the negative example degree computation unit 22 ends the processing. On the other hand, if the result of the determination of step B15 indicates that the end condition has not been satisfied (if the computed difference is not within the set range), the negative example degree computation unit 22 causes the latent information extraction unit 23 to execute step B12 again. Steps B12 to B15 are thereby executed again.

Accordingly, it is assumed that, in the initial step B12, the latent information extraction unit 23, first, sets matrix elements of the adjacency matrix of relational data to 0.5 rather than 0. Thereafter, steps B12 to B15 are repeatedly executed, and the latent information extraction unit 23 updates the value of the elements of the adjacency matrix from 0.5 to a value that depends on the negative example degree.

In this way, according to the first variation, latent information is repeatedly updated, and the negative example degrees are also updated using the updated latent information. According to the first variation, it thus becomes possible to compute negative example degrees with even higher accuracy.

[Second Variation]

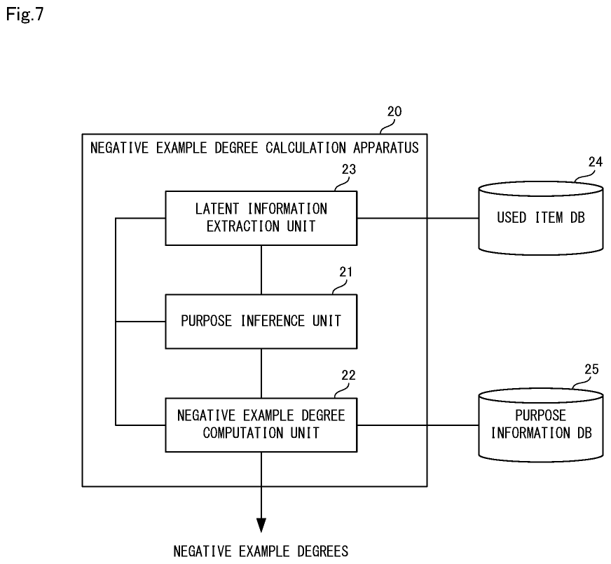

Next, a second variation of the negative example degree calculation apparatus, the negative example degree calculation method and the program in the second example embodiment will be described using FIG. 7. FIG. 7 is a diagram showing the configuration of the second variation of the negative example degree calculation apparatus in the second example embodiment of the invention.

As shown in FIG. 7, in the second variation, the negative example degree calculation apparatus 20 is also connected to the purpose information DB 14, in addition to the used item DB 13, similarly to the negative example degree calculation apparatus 10 in the first example embodiment shown in FIG. 1. In the second variation, a negative example degree computation unit 25 computes the negative example degree of each item, using purpose information acquired from the purpose information DB 14, in addition to the latent information and the purpose.

Specifically, it is assumed, similarly to the above-mentioned example, that vector q has been extracted by the latent information extraction unit 23 as the latent information of each item, and latent information vector qi of a certain item i has been inferred by the purpose inference unit 21 as the purpose for which a certain user used item i. Also, in this case, it is assumed that the negative example degree computation unit 25 has acquired the category (health food, facial cleanser, clothing, etc.) of each item as the purpose information of the item from the purpose information DB 14.

In the second variation, the negative example degree computation unit 22, similarly to the above-mentioned example, is then able to calculate the negative example degree using the cosine of purpose information vector qi of item i and latent information vector qj of item j, namely, cos θ(qi, qj)=qi·qj/(|qi∥qj|). In the second variation, however, the negative example degree computation unit 22 determines whether item i and item j belong to the same category, based on the purpose information, and calculates the negative example degree, only if the result of the determination indicates that both items belong to the same category. For example, assuming that the items are videos on video viewing sites, the negative example degree computation unit 22, in the case where the category of item i is action movie, calculates the negative example degree, if the category of item j is also action movie.

According to the second variation, purpose information that is stored in the purpose information DB 14 is used in calculating the negative example degrees, thus enabling the negative example degrees to be calculated with even higher accuracy.

Also, the case where a history indicating that a certain user purchased a zero calorie drink is recorded as relational data, as mentioned in the first example embodiment, will be examined here. In this case, it is assumed that the purpose information for that zero calorie drink is vector v in which 1 is assigned to the purpose items “for health”, “want something sweet” and “want something to drink”, and 0 is assigned to the remaining purpose items. Also, it is assumed that, at the same time, the latent information extraction unit 23 has extracted q as the latent information vector of the zero calorie drink. In this case, in the second variation, the purpose inference unit 21 is able to connect these two vectors and output, as the purpose, (v, q) converted into a single vector.

### Third Example Embodiment

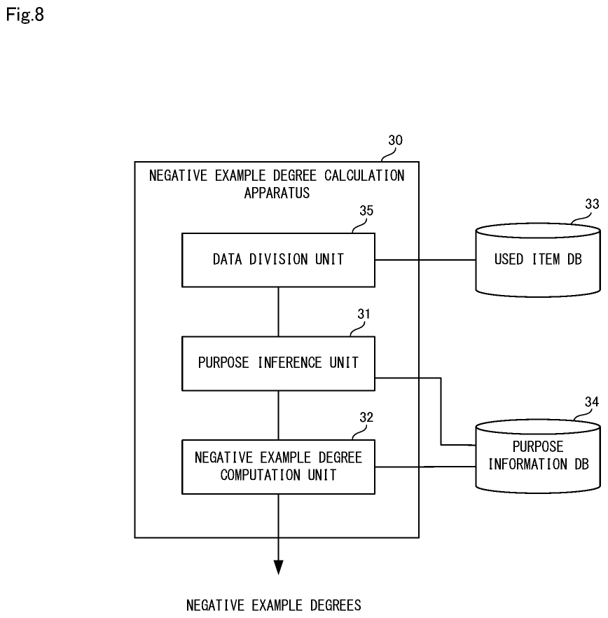

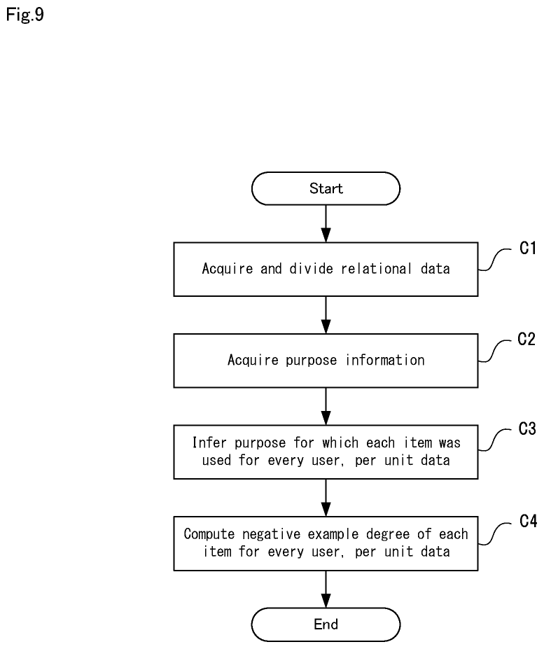

Next, a negative example degree calculation apparatus, a negative example degree calculation method and a program in a third example embodiment of the invention will be described, with reference to FIGS. 8 and 9.

[Apparatus Configuration]

Initially, the configuration of the negative example degree calculation apparatus in the third example embodiment will be described using FIG. 8. FIG. 8 is a block diagram showing a specific configuration of the negative example degree calculation apparatus in the third example embodiment of the invention.

As shown in FIG. 4, a negative example degree calculation apparatus 30 in the third example embodiment differs from the negative example degree calculation apparatus 10 in the first example embodiment shown in FIGS. 1 and 2 in terms of being provided with a data division unit 35. Hereinafter, the description will focus on the differences from the first example embodiment.

As shown in FIG. 4, the negative example degree calculation apparatus 30 in the third example embodiment is provided with a purpose inference unit 31, a negative example degree computation unit 32, and a data division unit 35. Also, the negative example degree calculation apparatus 30 is connected to a used item DB 33 and a purpose information DB 34. Note that the used item DB 33 is a similar database to the used item DB 13 shown in the first example embodiment, and the purpose information DB 34 is a similar database to the purpose information DB 14 shown in the first example embodiment.

The data division unit 35 divides the relational data that is stored in the used item DB 33 into a plurality of segments chronologically. In other words, the data division unit divides the use history of items of each user at designated intervals.

Specifically, the data division unit 35 divides the relational data, using an established time interval, a temporal interval such as day or month, or the like, for example. Also, the data division unit 35 may extract the times in relational data at which the user used items, set a plurality of segments based on the extracted times, such that a number of used items are collected together, and divide the relational data. Furthermore, the data division unit 35 is, in the case where login times of the user or the times at which the user visited stores are recorded in relational data, also able to divide the relational data, using these times. Also, in the subsequent description, the individual pieces of divided relational data (use history) will be described as “unit data”.

The purpose inference unit 31, in the third example embodiment, infers the purpose of use of each item for every user, per segment used in division, from the divided relational data (unit data) and the purpose information that is stored in the purpose information DB 34.

Here, the case where from one login to logoff is treated as unit data, in the case where relational data is the viewing history of video viewing sites by a user, for example, will be described. In this case, the purpose inference unit 31 is able to specify the genres of video that has been viewed, using the purpose information, from one login to logout, and count how many times each specified genre has been viewed. The purpose inference unit 31 is then able to infer the genre that has been viewed most frequently as the purpose for which the user used items in this unit data.

Specifically, it is assumed that the user viewed videos ten times from one login to logoff, consisting of action movies six times, sci-fi movies three times, and comedy movies one time when sorted by genre. In this case, the purpose inference unit 31 infers “action” as the purpose for which the user used items in this unit data.

Also, the purpose inference unit 31 is also able to represent the purpose of the user with a vector whose components are the viewing frequencies of the respective genres. For example, in the case of the above-mentioned example, the purpose inference unit 31 creates a vector whose components are action, science fiction, comedy and other genres, with action, science fiction and comedy respectively being 6, 3 and 1, and the other components being 0.

Also, in the third example embodiment, the negative example degree computation unit 32 computes negative example degrees for the items of each user, per segment used in division (per unit data). Specifically, the negative example degree computation unit 32, in the case of the above-mentioned example, computes the negative example degrees, such that a large negative example degree is assigned to items that were not selected (videos that were not viewed) among the items of genres inferred as the purpose in the unit data from one login to logoff.

[Apparatus Operations]

Next, operations of the negative example degree calculation apparatus 30 in the third example embodiment of the invention will be described using FIG. 9. FIG. 9 is a flow diagram showing operations of the negative example degree calculation apparatus in the third example embodiment of the invention. In the following description, FIG. 8 is taken into consideration as appropriate. Also, in the third example embodiment, the negative example degree calculation method is implemented by operating the negative example degree calculation apparatus 30. Therefore, the following description of the operations of the negative example degree calculation apparatus 30 will be given in place of a description of the negative example degree calculation method in the third example embodiment.

As shown in FIG. 9, first, the data division unit 35 acquires relational data from the used item DB 33, and divides the acquired relational data into a plurality of segments (unit data) chronologically (step C1).

Next, the purpose inference unit 31 acquires relational data from the used item DB 33 (step C2).

Next, the purpose inference unit 31 infers the purpose of use of each item for every user, per segment used in division, from the relational data divided in step C1 and the purpose information acquired in step C2 (step C3).

Next, the negative example degree computation unit 32 computes negative example degrees for the items of each user, per segment used in division (per unit data) (step C4). Specifically, the negative example degrees are computed such that a large negative example degree is assigned to items that were not selected in a specific segment, among items whose purpose according to the purpose information is close to the inferred purpose (step C4).

The processing in the negative example degree calculation apparatus 30 provisionally ends after execution of step C4. The negative example degrees computed in step C4 are, for example, used in a recommendation system that recommends products or content. Note that illustration of the recommendation system has been omitted in FIG. 8.

### Effects of Third Embodiment

As described above, according to the third example embodiment, relational data is divided chronologically, and purpose inference is performed per unit data obtained by division. The purpose of use by users can thus be clarified, even in the case where the user does not have a clear use purpose for every use of an item. In other words, in the fourth example embodiment, the purpose of the user can be clarified even in the case where the user selected an item for vague reasons, and thus the “unclear purpose” of the user when using the service can also be incorporated. According to the fourth example embodiment, the negative example degrees can thus be computed with even higher accuracy.

Also, in the case where the negative example degrees obtained by the third example embodiment are applied in a recommendation system, the processing time taken for recommendation in the recommendation system can be shortened, similarly to the first example embodiment.

[Program]

A program in the third example embodiment need only be a program that causes a computer to execute steps C1 to C4 shown in FIG. 9. The negative example degree calculation apparatus 30 and the negative example degree calculation method in the fourth example embodiment can be realized, by this program being installed on a computer and executed. In this case, a processor of the computer performs processing while functioning as the purpose inference unit 31, the negative example degree computation unit 32, and the data division unit 35.

Also, in the third example embodiment, the used item DB 33 and the purpose information DB 34 can be realized by storing data files constituting these databases in a storage device such as a hard disk provided in the computer. Also, in this case, the computer may be a computer on which the program of the third example embodiment is installed, or may be another computer connected to this computer.

Also, the program in the third example embodiment may be executed by a computer system built from a plurality of computers. In this case, for example, the computers may respectively function as one of the purpose inference unit 31, the negative example degree computation unit 32, and the data division unit 35.

### Fourth Example Embodiment

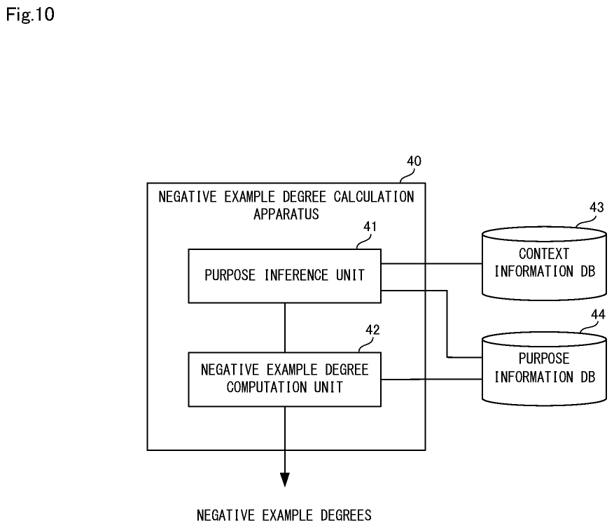

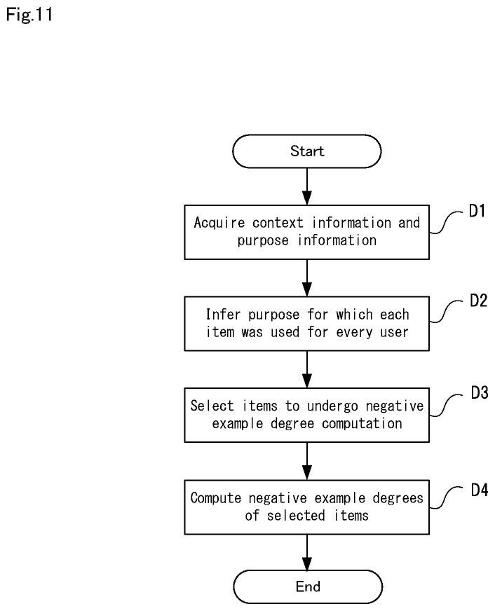

Next, a negative example degree calculation apparatus, a negative example degree calculation method and a program in a fourth example embodiment of the invention will be described, with reference to FIGS. 10 and 11.

[Apparatus Configuration]

Initially, the configuration of the negative example degree calculation apparatus in the fourth example embodiment will be described using FIG. 10. FIG. 10 is a block diagram showing a specific configuration of the negative example degree calculation apparatus in the fourth example embodiment of the invention.

As shown in FIG. 10, a negative example degree calculation apparatus 40 in the fourth example embodiment is provided with a purpose inference unit 41 and a negative example degree computation unit 42, similarly to the negative example degree calculation apparatus 10 in the first example embodiment shown in FIG. 2. Also, the negative example degree calculation apparatus 40 is connected to a purpose information DB 44, similarly to the negative example degree calculation apparatus 10 in the first example embodiment. In the fourth example embodiment, however, the negative example degree calculation apparatus 40 differs from the negative example degree calculation apparatus 10 in the first example embodiment in being connected to a context information DB 43. Hereinafter, the description will focus on the differences from the first example embodiment.

As shown in FIG. 10, the negative example degree calculation apparatus 40 in the fourth example embodiment is connected to the purpose information DB 44, similarly to the first example embodiment, but is not connected to a used item DB, and is instead connected to the context information DB 43. Note that the purpose information DB 44 is a similar database to the purpose information DB 14 shown in the first example embodiment.

The context information DB 43 stores context information. Context information includes information relating to when an item specified by relational data was used. Specifically, context information includes the price of an item, the period from sale of an item, the ranking of an item, the season at the time of use, the day at the time of use, the weather at the time of use, the place at the time of use, and sales information. Context information also includes information specifying the circumstances leading to use of an item, such as a search term used when specifying an item, a browsing history of a website by a user, a medium on which an item was carried, and the path to and means for visiting a website by a user, for example. Note that, in the fourth example embodiment, the relational data is itself also included in the context information.

The purpose inference unit 41, in the fourth example embodiment, infers the purpose for which users used items in the past from the context information and the purpose information. In other words, the purpose inference unit 41 infers the purpose using information relating to when the item was used, such as the above-mentioned sales information or search term, for example, in addition to the purpose information.

Specifically, assume that the context information includes “cheap” as a search phrase used when a bath towel was purchased on an EC site, for example. In this case, it is possible to add “for economizing” in addition to “for drying body” to the purpose that was originally inferred. Therefore, in the fourth example embodiment, the purpose inference unit 41 infers “for economizing” and “for drying body” as the purpose.

Also, the negative example degree computation unit 42, in the fourth example embodiment, selects items to undergo negative example degree computation, based on the context information, and compute negative example degrees for the selected items, based on the inferred purpose and the purpose information. In other words, in the fourth example embodiment, the negative example degree computation unit 42 specifies “popular items” or new products that tend to catch the eye of the user from the context information, and computes negative example degrees for the specified items.

Here, an example computation of negative example degrees in the fourth example embodiment will be described, while comparing the second and fourth example embodiments.

In the above-mentioned second example embodiment, the case where vector q is extracted by the latent information extraction unit 23 as the latent information of each item, and latent information vector qi of a certain item i is inferred by the purpose inference unit 21 as the purpose information vector for when a certain user used item i was described as an example. In this case, in the second example embodiment, the negative example degree computation unit 22 calculates the negative example degree using the cosine of purpose information vector qi of item i and latent information vector qj of another item j, namely, cos θ(qi, qj)=qi·qj/(|qi∥qj|). In other words, in the second example embodiment, the negative example degree z for item j is calculated as z=1+cos θ(qi, qj).

In contrast, in the fourth example embodiment, it is assumed that the category (health food, a facial cleanser, clothing, etc.) of items has been assigned to context information. In this case, the negative example degree computation unit 42 selects items to undergo negative example degree computation, rather than calculating z for all items j.

For example, assume that items j1, j2, . . . , j30 are introduced in the context information as the top 30 popular items within the category to which item i belongs at the time of purchase. At this time, it can be inferred that the user recognizes only these top 30 items and has comparatively examined these items, for example. Accordingly, the negative example degree computation unit 42 selects these items j1, j2, . . . , j30, and limits computation of the negative example degrees to these items.

Also, in the fourth example embodiment, assuming that the category of item i has been given, a set of items j in which cos θ(qi, qj) is less than or equal to a certain threshold value can be envisaged, thus enabling creation of a list of items close to item i. The items in this list can also be regarded as belonging to the same category as item i. In this case, the negative example degree computation unit 42 computes negative example degrees for only the items that appears in the list. In this way, according to the fourth example embodiment, it becomes possible, in the case where each item is given a popularity rating using the context information, to narrow down computation of the negative example degrees to the most top 30 popular items from this list of items.

[Apparatus Operations]

Next, operations of the negative example degree calculation apparatus 40 in the fourth example embodiment of the invention will be described using FIG. 11. FIG. 11 is a flow diagram showing operations of the negative example degree calculation apparatus in the fourth example embodiment of the invention. In the following description, FIG. 10 will be taken into consideration as appropriate. Also, in the fourth example embodiment, the negative example degree calculation method is implemented by operating the negative example degree calculation apparatus 40. Therefore, the following description of the operations of the negative example degree calculation apparatus 40 will be given in place of a description of the negative example degree calculation method in the fourth example embodiment.

As shown in FIG. 11, initially, the purpose inference unit 41 acquires context information from the context information DB 43, and acquires purpose information from the purpose information DB 44 (step D1). Next, the purpose inference unit 11 infers, for every user, what the purpose was when the user used each item, based on the context information and the purpose information of purchased items (step D2).

Next, upon execution of step D2, the negative example degree computation unit 12 selects items to undergo negative example degree computation, based on the context information acquired in step D1 (step D3).

Next, the negative example degree computation unit 12 computes the negative example degrees for the items selected in step D3, based on the purpose inferred in step D2 and the purpose information (step D4).

The processing in the negative example degree calculation apparatus 40 provisionally ends after execution of step D4. The negative example degrees computed in step D4 are, for example, used in a recommendation system that recommends products or content to users. Note that illustration of the recommendation system has been omitted in FIG. 10.

### Effects of Fourth Embodiment

As described above, according to the fourth example embodiment, a more exact purpose is inferred using context information, thus allowing negative example degrees to be computed with high accuracy. Also, the items that require computation of a negative example degree is narrowed down, thus allowing an improvement in processing speed in the negative example degree calculation apparatus 40 to be achieved.

Also, in the case where the negative example degrees obtained by the fourth example embodiment are applied in a recommendation system, the processing time taken for recommendation in the recommendation system can be shortened, similarly to the first example embodiment.

[Program]

A program in the fourth example embodiment need only be a program that causes a computer to execute steps D1 to D4 shown in FIG. 11. The negative example degree calculation apparatus 40 and the negative example degree calculation method in the fourth example embodiment can be realized, by this program being installed on a computer and executed. In this case, a processor of the computer performs processing while functioning as the purpose inference unit 41 and the negative example degree computation unit 42.

Also, in the fourth example embodiment, the context information DB 43 and the purpose information DB 44 can be realized by storing data files constituting these databases in a storage device such as a hard disk provided in the computer. Also, in this case, the computer may be a computer on which the program of the fourth example embodiment is installed, or may be another computer connected to this computer.

Also, the program in the fourth example embodiment may be executed by a computer system built from a plurality of computers. In this case, for example, the computers may respectively function as one of the purpose inference unit 41 and the negative example degree computation unit 42.

### Fifth Example Embodiment

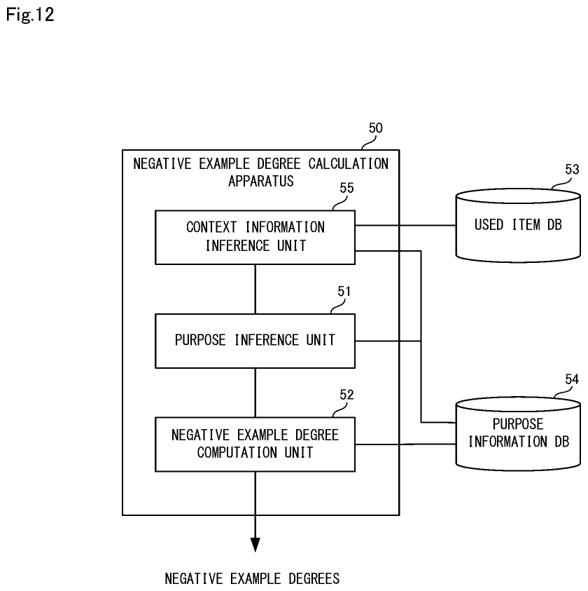

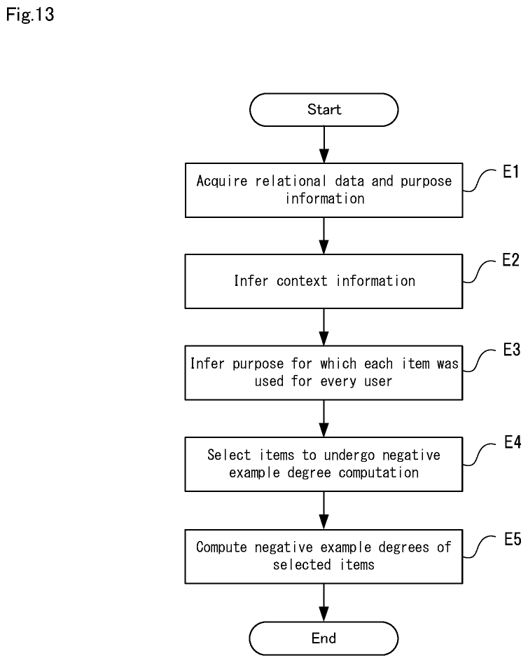

Next, a negative example degree calculation apparatus, a negative example degree calculation method and a program in a fifth example embodiment of the invention will be described, with reference to FIGS. 12 and 13.

[Apparatus Configuration]

Initially, the configuration of the negative example degree calculation apparatus in the fifth example embodiment will be described using FIG. 12. FIG. 12 is a block diagram showing a specific configuration of the negative example degree calculation apparatus in the fifth example embodiment of the invention.

As shown in FIG. 12, a negative example degree calculation apparatus 40 in the fourth example embodiment is provided with a purpose inference unit 51, a negative example degree computation unit 52, and a context information inference unit 55. The negative example degree calculation apparatus 40 differs from the first example embodiment in terms of being provided with the context information inference unit 55. Note that the negative example degree calculation apparatus 40 is also connected to a used item DB 53 and a purpose information DB 54. Hereinafter, the description will focus on the differences from the first example embodiment.

The context information inference unit 55 infers, based on relational data and purpose information, context information that includes information relating to when items that are specified by the relational data were used. The context information is as described in the fourth example embodiment. Also, the context information inference unit 55 outputs the inferred context information and the relational data to the purpose inference unit 51.

Specifically, when a certain user uses a certain item, for example, the context information inference unit 55 calculates a sales number c of each item at that point in time. The context information inference unit 55 then creates, as context information, vectors in which the number of components equals the number of items, and each component is set to the sales number c of the corresponding component. The vectors created in this manner indicate the popularity rating of the respective items.

The context information inference unit 55 is also able to compute, for every item, the reciprocal [1/(t−t0)] of the difference between item use time t and time t0 at which the item appeared. In this case, the context information inference unit 55 creates, as context information, vectors in which the number of components equals the number of items, and each element is set to the reciprocal of the corresponding component. The vectors created in this manner indicate the newness of items at use time t.

Also, assuming that around the time that a certain user used an item, a large number of other users were using items having specific purpose information, those other users will also conceivably tend to have a similar purpose. For example, in the case where it can be judged from relational data that a large number of users have purchased health food whose purpose information is health mindedness, health mindedness is considered to be booming, and there is a possibility that another users will also purchase health products. Therefore, the context information inference unit 55, in the case where a boom can be judged from relational data, infers the judged boom, such as information indicating “health boom”, for example, as context information.

Specifically, the context information inference unit 55 infers a weighted average Σj(cj·vj)/N of sales number cj of items j within a certain period and purpose information vj of items j as context information resulting from a boom. Also, in this case, the context information inference unit 55 is able to output the context information as a vector. Here, sum Σ is computed from index j of items.

The purpose inference unit 51, in the fifth example embodiment, infers the purpose for which users used items in the past from the context information inferred by the context information inference unit 55 and the purpose information that is stored in the purpose information DB 54. The purpose inference unit 51 functions similarly to the purpose inference unit 41 in the fourth embodiment shown in FIG. 10.

For example, assume that a certain user having purchased a zero calorie drink has been recorded as relational data, as described in the first example embodiment. In this case, the purpose inference unit 51 infers vector v1 in which 0.3, 0.5 and 0.2 are respectively given to the purpose items “for health”, “want something sweet” and “want something to drink” and 0 is given to the remaining purpose items, with regard to zero calorie drinks, based on the purpose information.

Also, in the above case, it is assumed that the context information is the vector Σj(cj·vj)/N representing a boom, and the vector is an input in which “for health” is 0.3 and the remaining purpose items are 0. In this case, for example, the purpose of the user is affected by the boom, and thus the purpose inference unit 51 is able to represent the purpose of the user by the sum of the two vectors [v1+Σj(cj·vj)/N]. Accordingly, in the above example, the purpose inference unit 51 outputs a vector in which 0.6, 0.5 and 0.2 are respectively given to the purpose items “for health”, “want something sweet” and “want something to drink” and 0 is given to the remaining purpose items.

The negative example degree computation unit 52, in the fifth example embodiment, selects items to undergo negative example degree computation, based on the context information, and computes negative example degrees for the selected items. The negative example degree computation unit 52 functions similarly to the negative example degree computation unit 42 in the fourth embodiment shown in FIG. 10.

For example, assume that the top 30 popular items when item i was purchased are given as context information, as described in the fourth example embodiment. At this time, the negative example degree computation unit 52 is able to select only these top 30 popular items, and compute negative example degrees for only the selected items. Also, in the case where the context information includes sales cj at that time for every item j and newness nj of items j when used, the negative example degree computation unit 52 is able to calculate cj+nj, for example, and select items whose negative example degree is to be computed from the calculation results.

[Apparatus Operations]

Next, operations of the negative example degree calculation apparatus 50 in the fifth example embodiment of the invention will be described using FIG. 13. FIG. 13 is a flow diagram showing operations of the negative example degree calculation apparatus in the fifth example embodiment of the invention. In the following description, FIG. 12 will be taken into consideration as appropriate. Also, in the fifth example embodiment, the negative example degree calculation method is implemented by operating the negative example degree calculation apparatus 50. Therefore, the following description of the operations of the negative example degree calculation apparatus 50 will be given in place of a description of the negative example degree calculation method in the fifth example embodiment.

As shown in FIG. 11, initially, the context information inference unit 55 acquires relational data from the used item DB 53, and acquires purpose information from the purpose information DB 54 (step E1). Next, the context information inference unit 55 infers context information, based on the relational data and purpose information acquired in step E1 (step E2).

Next, the purpose inference unit 51 receives the relational data and context information from the context information inference unit 55, further acquires purpose information from the purpose information DB 44, and infers, for every user, what the purpose was when the user used each item, using the various information (step E3).

Next, upon step E3 being executed, the negative example degree computation unit 52 selects items to undergo negative example degree computation, based on the context information inferred in step E2 (step E4).

Next, the negative example degree computation unit 12 computes the negative example degrees for the items selected in step E4, based on the purpose inferred in step E3 and the purpose information (step E5).

The processing in the negative example degree calculation apparatus 50 provisionally ends after execution of step E5. The negative example degrees computed in step E5 are, for example, used in a recommendation system that recommends products or content to users. Note that illustration of the recommendation system has been omitted in FIG. 12.

### Effects of Fifth Embodiment

As described above, in the fifth example embodiment, context information can be used, similarly to the fourth example embodiment, and a more exact purpose to be inferred, thus allowing negative example degrees to be computed with high accuracy. Also, items that require computation of a negative example degree is narrowed down, thus allowing an improvement in processing speed in the negative example degree calculation apparatus 50 to be achieved.

Also, in the case where the negative example degrees obtained by the fifth example embodiment are applied in a recommendation system, the processing time taken for recommendation in the recommendation system can be shortened, similarly to the first example embodiment.

[Program]

A program in the fifth example embodiment need only be a program that causes a computer to execute steps E1 to E5 shown in FIG. 13. The negative example degree calculation apparatus 50 and the negative example degree calculation method in the fifth example embodiment can be realized, by this program being installed on a computer and executed. In this case, a processor of the computer performs processing while functioning as the purpose inference unit 51, the negative example degree computation unit 52, and the context information inference unit 55.

Also, in the fifth example embodiment, the used item DB 53 and the purpose information DB 54 can be realized by storing data files constituting these databases in a storage device such as a hard disk provided in the computer. Also, in this case, the computer may be a computer on which the program of the fourth example embodiment is installed, or may be another computer connected to this computer.

Also, the program in the fifth example embodiment may be executed by a computer system built from a plurality of computers. In this case, for example, the computers may respectively function as one of the purpose inference unit 51, the negative example degree computation unit 52 and the context information inference unit 55.

### Sixth Example Embodiment

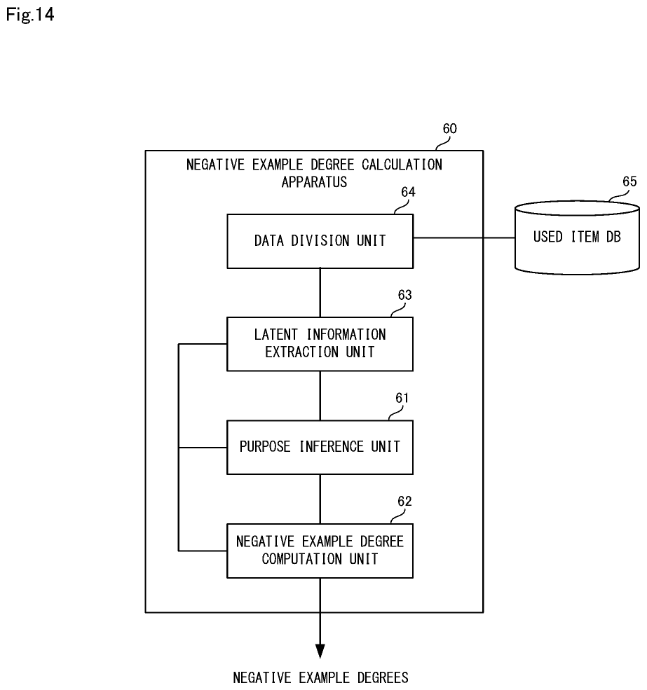

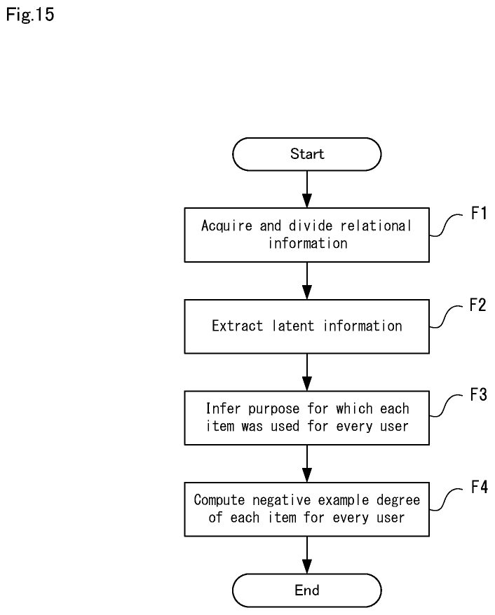

Next, a negative example degree calculation apparatus, a negative example degree calculation method and a program in a sixth example embodiment of the invention will be described, with reference to FIGS. 14 and 15.

[Apparatus Configuration]

Initially, the configuration of the negative example degree calculation apparatus in the sixth example embodiment will be described using FIG. 14. FIG. 14 is a block diagram showing a specific configuration of the negative example degree calculation apparatus in the sixth example embodiment of the invention.

As shown in FIG. 14, a negative example degree calculation apparatus 60 in the sixth example embodiment is provided with a purpose inference unit 61, a negative example degree computation unit 62, a latent information extraction unit 63, and a data division unit 64. Also, the negative example degree calculation apparatus 60 is connected to a used item DB 65. The negative example degree calculation apparatus 60 differs from the negative example degree calculation apparatus 20 in the second embodiment shown in FIG. 4 in terms of being provided with the data division unit 64. Hereinafter, the description will focus on the differences from the second example embodiment.

The data division unit 64 divides the relational data that is stored in the used item DB 65 into a plurality of segments chronologically. The data division unit 64 is provided with a similar function to the data division unit 35 shown in FIG. 8 in the third example embodiment.

The latent information extraction unit 63 generates a matrix specifying items used by users from the users and items that are included in the relational data, similarly to the latent information extraction unit 23 in the second example embodiment. Also, the latent information extraction unit 63 derives vectors representing the preference of users and vectors representing the latent attribute of items from the generated matrix, and extracts latent information from the derived vectors. In the sixth example embodiment, however, the latent information extraction unit 63 extracts latent information every divided segment.

The purpose inference unit 61, in the sixth example embodiment, infers the purpose of use of each item for every user, per segment used in division, using the latent information. The purpose inference unit 61, for example, derives a latent information vector, for every item used in the unit period, and computes the average value of the derived latent information vectors. Subsequently, the purpose inference unit 61 outputs a vector of the computed average value as the purpose.

Specifically, assume that a user viewed video 1, video 2, . . . , video 10 in a certain unit period. Assume also that latent information vectors q1, q2, . . . , q10 were given by the latent information extraction unit 63 with regard to the unit period. In this case, the purpose inference unit 61 calculates, as the purpose of the user, average value qu of the vectors, namely, qu=(q1+q2+ . . . +q10)/10, and outputs the average value obtained by the calculation as the purpose of the user.

The negative example degree computation unit 62 computes the negative example degrees, using the latent information, similarly to the negative example degree computation unit 22 in the second example embodiment. In the sixth example embodiment, however, the negative example degree computation unit 62 computes the negative example degrees every divided segment.

Specifically, the negative example degree computation unit 62 is able to calculate the negative example degree using the cosine of purpose information vector qu of a certain video i, and latent information vector q of the other videos, namely, cos θ(qu, q)=qu·q/(|qu∥q|). That is, the negative example degree z can be defined for each video j as (1+cos θ(qu, qj))/2. Note that the sixth example embodiment differs from the second example embodiment in that division by 2 is performed in order for the negative example degree z to satisfy 0<z<1.

[Apparatus Operations]

Next, operations of the negative example degree calculation apparatus 60 in the sixth example embodiment of the invention will be described using FIG. 15. FIG. 15 is a flow diagram showing operations of the negative example degree calculation apparatus in the sixth example embodiment of the invention. In the following description, FIG. 14 will be taken into consideration as appropriate. Also, in the sixth example embodiment, the negative example degree calculation method is implemented by operating the negative example degree calculation apparatus 60. Therefore, the following description of the operations of the negative example degree calculation apparatus 60 will be given in place of a description of the negative example degree calculation method in the sixth example embodiment.

As shown in FIG. 15, initially, the data division unit 64 acquires relational data from the used item DB 65, and divides the acquired relational data into a plurality of segments (unit data) chronologically (step F1).

Next, the latent information extraction unit 23 generates a matrix specifying the items used by the user, per segment used in division, from the users and items that are included in the relational data acquired in step F1. The latent information extraction unit 23 then derives vectors representing the preference of users and vectors representing the latent attribute of items from the generated matrix, and extracts latent information from the derived vectors per segment used in division (step F2).

Next, the purpose inference unit 21 infers the purpose for which users used items in the past, per segment used in division, using the latent information extracted in step F2 (step F3). Next, the negative example degree computation unit 22 computes the negative example degree of each item of each user, per segment used in division, using the purpose inferred in step F3 and the latent information extracted in step F2 (step F4).

The processing in the negative example degree calculation apparatus 20 provisionally ends after execution of step F4. The negative example degrees computed in step F4 are, for example, used in a recommendation system that recommends products or content to users. Note that illustration of the recommendation system has been omitted in FIG. 14.

### Effects of Sixth Embodiment

As described above, in the case of using the sixth example embodiment, relational data is divided chronologically, and purpose inference is performed per unit data obtained by division, similarly to the third example embodiment. The purpose of use by users can thus be clarified, even in the case where the user does not have a clear use purpose for every use of an item.

Also, in the case where the negative example degrees obtained by the sixth example embodiment are applied in a recommendation system, the processing time taken for recommendation in the recommendation system can be shortened, similarly to the first example embodiment.

[Program]

A program in the sixth example embodiment need only be a program that causes a computer to execute steps F1 to F4 shown in FIG. 15. The negative example degree calculation apparatus 60 and the negative example degree calculation method in the sixth example embodiment can be realized, by this program being installed on a computer and executed. In this case, a processor of the computer performs processing while functioning as the purpose inference unit 61, the negative example degree computation unit 62, the latent information extraction unit 63, and the data division unit 64.

Also, in the sixth example embodiment, the used item DB 65 can be realized by storing data files constituting this database in a storage device such as a hard disk provided in the computer. Also, in this case, the computer may be a computer on which the program of the sixth example embodiment is installed, or may be another computer connected to this computer.

Also, the program in the sixth example embodiment may be executed by a computer system built from a plurality of computers. In this case, for example, the computers may respectively function as one of the purpose inference unit 61, the negative example degree computation unit 62, the latent information extraction unit 63, and the data division unit 64.

[Variation]

The sixth example embodiment may also have a similar configuration to the first variation of the second example embodiment. In other words, the latent information extraction unit 63, after generating a matrix, is able to update the matrix, using the negative example degrees computed by the negative example degree computation unit 62, and to further extract new latent information from the updated matrix. Also, the purpose inference unit 21 is able to infer the purpose again using the new latent information, and the negative example degree computation unit 62 is able to compute the negative example degrees again using new latent information.

[Physical Configuration]

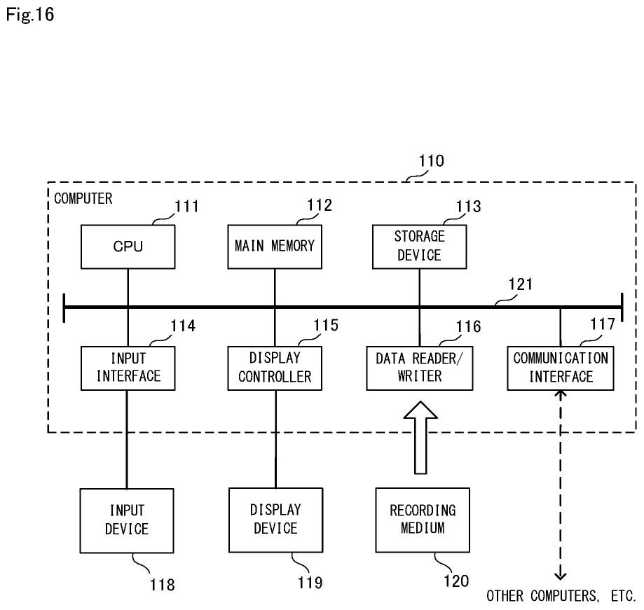

Here, a computer that realizes a negative example degree calculation apparatus, by executing a program according to the first to sixth example embodiments will be described using FIG. 16. FIG. 16 is a block diagram showing an example of a computer that realizes the negative example degree calculation apparatus according to the first to sixth example embodiments of the invention.

As shown in FIG. 16, a computer 110 includes a CPU 111, a main memory 112, a storage device 113, an input interface 114, a display controller 115, a data reader/writer 116, and a communication interface 117. These units are connected to each other in a manner that enables data communication, via a bus 121. Note that the computer 110 may include a GPU (Graphics Processing Unit) or an FPGA (Field-Programmable Gate Array), in addition to the CPU 111 or instead of the CPU 111.

The CPU 111 implements various computational operations, by extracting program (codes) of the example embodiments that are stored in the storage device 113 to the main memory 112, and executing these codes in predetermined order. The main memory 112, typically, is a volatile storage device such as a DRAM (Dynamic Random Access Memory). Also, programs according to the example embodiments are provided in a state of being stored in a computer readable recording medium 120. Note that programs according to the example embodiments may be distributed over the Internet connected via the communication interface 117.

Also, a semiconductor storage device such as a flash memory is given as a specific example of the storage device 113, other than a hard disk drive. The input interface 114 mediates data transmission between the CPU 111 and input devices 118 such as a keyboard and a mouse. The display controller 115 is connected to a display device 119 and controls display on the display device 119.

The data reader/writer 116 mediates data transmission between the CPU 111 and the recording medium 120, and executes readout of programs from the recording medium 120 and writing of processing results of the computer 110 to the recording medium 120. The communication interface 117 mediates data transmission between the CPU 111 and other computers.

Also, a general-purpose semiconductor storage device such as a CF (Compact Flash (registered trademark)) card or an SD (Secure Digital) card, a magnetic recording medium such as a flexible disk, and an optical recording medium such as a CD-ROM (Compact Disk Read Only Memory) are given as specific examples of the recording medium 120.

Note that the negative example degree calculation apparatus according to the example embodiments is also realizable by using hardware corresponding to the respective units, rather than by a computer on which programs are installed. Furthermore, the negative example degree calculation apparatus may be realized in part by programs, and the remaining portion may be realized by hardware.

### WORKING EXAMPLES

Next, the negative example degree calculation apparatus, the negative example degree calculation method and the program in the example embodiments of the invention will be specifically described using specific working examples.

### First Working Example

The first working example is a working example of the first example embodiment. In the first working example, purchase of items by users on EC sites is envisaged. In this first working example, the relational data is data recording the purchase histories of items by users.

It is assumed that the purpose information is information that relates to “the purpose for which the user uses the item”, and has been recorded with vectors whose components are respective purpose items. For example, assume that the item is a zero calorie drink. In this case, a vector in which 0.5, 0.2 and 0.3 are respectively assigned to the purpose items “for health”, “want something sweet” and “want something to drink”, and 0 is assigned to the remaining purpose items (e.g., other items such as “want something to eat”) is given as the purpose information vector.

Because the user having purchased a zero calorie drink is known from the relational data, and a purpose information vector of the zero calorie drink is known from the purpose information, the purpose inference unit 11 outputs the purpose information vector of the zero calorie drink as the purpose of the user.

Here, a sickly sweet drink A, a health-oriented food B, and a zero calorie drink C from another brand are envisaged as the other items. Also, in the purpose information of each item, the purpose items “for health”, “want something sweet” and “want something to drink” are respectively (0, 1, 0) for A, (0.6, 0.3, 0) for B, and (0.7, 0, 0.3) for C.

At this time, the negative example degree is defined by the inner product of a purpose vector indicating the purpose of the user and purpose information vector V indicating the purpose information of the item, for example. Accordingly, in this case, the negative example degree of A will be U·V1=0.1, the negative example degree of B will be U·V2=0.39, and the negative example degree of C will be U·V3=0.51.

A similar calculation is performed on all purchased items of each user. The negative example degree z (u, i) of item i for user u that is calculated from all purchase results is, for example, computed as the sum of the inner products of the vectors of the respective items, that is, z(u, i)=αΣUut·Vi, where Uut is the purpose vector of user u in the tth purchase. Here, “sum” is computed for t, and α is a suitable coefficient.

As described above, according to the first working example, calculation of appropriate negative example degrees is possible.

### Second Working Example

The second working example is a working example of the third example embodiment. In the second working example, viewing of videos by users on video viewing sites is envisaged. In the second working example, the relational data is data recording videos viewed by users and viewing times. Also, it is assumed that the genres action, science fiction and comedy have been assigned to the videos. The purpose information records the genre of each video.

First, the data division unit 35, upon acquiring relational data, takes videos viewed within one day as one unit usage, with one day as the division segment.

Next, the purpose inference unit 31 infers the purpose of users, using purpose information vectors serving as purpose information for videos viewed within the above unit usage. For example, it is assumed that the genres (action, science fiction, comedy, etc.) have been set as the components of the purpose information vectors. Also, it is assumed that a certain user viewed videos ten times within the unit usage, and the purpose information vectors of those respective videos are given by v1, v2, . . . , v10.

In this case, the purpose inference unit 31 is able to use an average value (v1+v2+ . . . +v10)/10 of the vectors of the videos viewed within the unit usage, for example, as the purpose of the user (purpose information vector U). Here, it is assumed that a vector whose elements are action, science fiction, comedy and other genres is set, and that action, science fiction and comedy are respectively 0.6, 0.3 and 0.1 and other components are 0. The purpose inference unit 31 uses these to create vectors.

The negative example degree computation unit 32 computes a negative example degree for each item of the user from the vector indicating the purpose of the user and purpose information vector U. For example, assume that there are movies A, B and C that the user has not viewed, and that vectors V1, V2 and V3 in which the components of the purpose items are (1, 0, 0), (0, 0, 1) and (0.7, 0.3, 0) for action, science fiction and comedy and the remaining components are 0 are given as the purpose information.

In this case, movie A is an action movie, movie B is a comedy, and movie C is an action movie containing sci-fi elements. The negative example degree computation unit 32 computes the negative example degrees using the inner product of the vectors, for example. As a result, the negative example degrees for the movies A, B and C are respectively calculated as U·V1=0.6, U·V2=0.1, and U·V3=0.51.

As described above, according to the second working example, calculation of appropriate negative example degrees is possible.

### Third Working Example

The third working example is a working example of the fourth example embodiment. In the third working example, context information that is stored in the context information DB 43 is used.

In above-mentioned first and second working examples, a negative example (weighted depending on whether the item is aligned with the purpose) is assigned to all the videos that users have not watched. However, it is not realistic for the user to be aware of all videos of the action genre and to make his or her selection after comparing all of those videos.

In the third working example, popularity rankings of videos are recorded as context information. The negative example degree computation unit 42 thus uses this context information, and, for example, judges that videos of the corresponding genre that have a high ranking (e.g., within the top 10) at the time of the unit usage and yet have not been viewed are videos whose existence the user is aware of but has shunned. The negative example degree computation unit 42 then computes the negative example degrees with consideration for the judgement result.

For example, assume that movie C is an action movie with a high popularity ranking, whereas movie A is outside the top rankings. Also, assume that movie B is a comedy and is thus not included in the action movie popularity rankings. In this case, the negative example degree computation unit 42 computes, as negative example degrees, U·V3=0.51 for movie C, and 0 for movies A and B.

As described above, according to the third working example, calculation of appropriate negative example degrees is possible using context information.

### Fourth Working Example

The fourth working example is a working example of the fifth example embodiment. In the fourth working example, the negative example degree calculation apparatus 50 is provided with the context information inference unit 55.

In the fourth working example, the context information inference unit 55 infers rankings by genre as context information from the relational data and the purpose information. That is, in the fourth working example, the context information inference unit 55 specifies the number of times that each video has been viewed per unit time in the past one month.

The context information inference unit 55 then checks the viewing frequency for the past one month for videos belonging to the genre (here, action) of the purpose of the user, ranks each video, and takes these rankings as context information.

In this case, the negative example degree computation unit 52 specifies videos that are highly ranked (e.g., within the top 30) using the context information and yet have not been viewed, among the videos of the action genre. The negative example degree computation unit 52 then judges that the user is aware of their existence but has shunned these videos, and selects these videos to undergo negative example degree computation.

Movie C has a viewing frequency of 500,000 views for the past month, and is ranked 8th in viewing frequency among action movies. On the other hand, movie A has a viewing frequency of 1000 views, and the viewing frequency among action movies is outside the top 30. In this case, the negative example degree computation unit 52 outputs U·V3=0.51 as “a video whose existence the user is aware of” for movie C ranked within the top 30 in viewing frequency, and outputs 0 as “a video whose existence the user is not aware of” for movies A and B.

As described above, calculation of appropriate negative example degrees is also possible using context information in the case of the fourth working example.

The example embodiments described above can be partially or wholly realized by supplementary notes 1 to 21 described below, although the invention is not limited to the following description.

(Supplementary Note 1)

A negative example degree calculation apparatus including:

a purpose inference unit configured to infer a purpose for which a user used an item in the past from relational data specifying the item used by the user in the past and purpose information indicating a use purpose of the item by the user; and

a negative example degree computation unit configured to compute a negative example degree indicating a possibility of the item not being selected by the user, based on the inferred purpose and the purpose information.

(Supplementary Note 2)

The negative example degree calculation apparatus according to supplementary note 1,

in which, in a case where a negative example degree is computed for another item other than a specific item:

the purpose inference unit is configured to use the purpose information indicating the use purpose of the specific item by the user, and

the negative example degree computation unit is configured to compute the negative example degree, based on the inferred purpose and purpose information indicating the use purpose of the other item.

(Supplementary Note 3)

The negative example degree calculation apparatus according to supplementary note 1 or 2, further including:

a latent information extraction unit configured to generate a matrix specifying the item used by the user from the user and the item that are included in the relational data, and to derive a vector representing a preference of the user and a vector representing a latent attribute of the item from the generated matrix, and extract latent information from the derived vectors,

in which the purpose inference unit is configured to infer the purpose for which the user used the item in the past, using the latent information instead of the relational data and the purpose information, and

the negative example degree computation unit is configured to compute the negative example degree, using the latent information instead of the purpose information.

(Supplementary Note 4)

The negative example degree calculation apparatus according to supplementary note 3,

in which the latent information extraction unit is configured to update the matrix after generation of the matrix, using the negative example degree computed by the negative example degree computation unit, and extract new latent information from the updated matrix,

the purpose inference unit is configured to infer the purpose again, using the new latent information, and

the negative example degree computation unit is configured to compute the negative example degree again, using the new latent information.

(Supplementary Note 5)

The negative example degree calculation apparatus according to any one of supplementary notes 1 to 4, further including:

a data division unit configured to divide the relational data into a plurality of segments chronologically,

in which the purpose inference unit is configured to infer the purpose from the divided relational data and the purpose information, per segment used in the division, and

the negative example degree computation unit is configured to compute the negative example degree, per segment.

(Supplementary Note 6)

The negative example degree calculation apparatus according to supplementary note 1 or 2,

in which the purpose inference unit is configured to infer the purpose from the purpose information and context information that includes information relating to when the item specified by the relational data was used, and

the negative example degree computation unit is configured to select the item to undergo computation of the negative example degree, based on the context information, and compute the negative example degree for the selected item.

(Supplementary Note 7)

The negative example degree calculation apparatus according to supplementary note 1 or 2, further including:

a context information inference unit configured to infer context information that includes information relating to when the item specified by the relational data was used, based on the relational data and the purpose information,

in which the purpose inference unit is configured to infer the purpose from the context information and the purpose information, and

the negative example degree computation unit is configured to select the item to undergo computation of the negative example degree, based on the context information, and compute the negative example degree for the selected item.

(Supplementary Note 8)

A negative example degree calculation method including:

(a) a step of inferring a purpose for which a user used an item in the past from relational data specifying the item used by the user in the past and purpose information indicating a use purpose of the item by the user; and

(b) a step of computing a negative example degree indicating a possibility of the item not being selected by the user, based on the inferred purpose and the purpose information.

(Supplementary Note 9)

The negative example degree calculation method according to supplementary note 8,

in which, in a case where a negative example degree is computed for another item other than a specific item:

in the (a) step, the purpose information indicating the use purpose of the specific item by the user is used, and

in the (b) step, the negative example degree is computed, based on the inferred purpose and purpose information indicating the use purpose of the other item.

(Supplementary Note 10)

The negative example degree calculation method according to supplementary note 8 or 9, further including:

(c) a step of generating a matrix specifying the item used by the user from the user and the item that are included in the relational data, and of deriving a vector representing a preference of the user and a vector representing a latent attribute of the item from the generated matrix, and extracting latent information from the derived vectors,

in which, in the (a) step, the purpose for which the user used the item in the past is inferred, using the latent information instead of the relational data and the purpose information, and

in the (b) step, the negative example degree is computed, using the latent information instead of the purpose information.

(Supplementary Note 11)

The negative example degree calculation method according to supplementary note 10,

in which, in the (c) step, the matrix is updated after generation of the matrix, using the negative example degree computed in the (b) step, and new latent information is extracted from the updated matrix,

in the (a) step, the purpose is inferred again, using the new latent information, and

in the (b) step, the negative example degree is computed again, using the new latent information.

(Supplementary Note 12)

The negative example degree calculation method according to any of supplementary notes 8 to 11, further including:

(d) a step of dividing the relational data into a plurality of segments chronologically,

in which, in the (a) step, the purpose is inferred from the divided relational data and the purpose information, per segment used in the division, and

in the (b) step, the negative example degree is computed, per segment.

(Supplementary Note 13)

The negative example degree calculation method according to supplementary note 8 or 9,

in which, in the (a) step, the purpose is inferred from the purpose information and context information that includes information relating to when the item specified by the relational data was used, and

in the (b) step, the item to undergo computation of the negative example degree is selected, based on the context information, and the negative example degree is computed for the selected item.

(Supplementary Note 14)

The negative example degree calculation method according to supplementary note 8 or 9, further including:

(e) a step of inferring context information that includes information relating to when the item specified by the relational data was used, based on the relational data and the purpose information,

in which, in the (a) step, the purpose is inferred from the context information and the purpose information, and

in the (b) step, the item to undergo computation of the negative example degree is selected, based on the context information, and the negative example degree is computed for the selected item.

(Supplementary Note 15)

A computer readable recording medium that includes a program recorded thereon, the program including instructions that cause a computer to carry out:

(a) a step of inferring a purpose for which a user used an item in the past from relational data specifying the item used by the user in the past and purpose information indicating a use purpose of the item by the user; and

(b) a step of computing a negative example degree indicating a possibility of the item not being selected by the user, based on the inferred purpose and the purpose information.

(Supplementary Note 16)

The computer readable recording medium according to supplementary note 15,

in which, in a case where a negative example degree is computed for another item other than a specific item:

in the (a) step, the purpose information indicating the use purpose of the specific item by the user is used, and

in the (b) step, the negative example degree is computed, based on the inferred purpose and purpose information indicating the use purpose of the other item.

(Supplementary Note 17)

The computer readable recording medium according to supplementary note 15 or 16, the program further including instructions that cause the computer to carry out:

(c) a step of generating a matrix specifying the item used by the user from the user and the item that are included in the relational data, and of deriving a vector representing a preference of the user and a vector representing a latent attribute of the item from the generated matrix, and extracting latent information from the derived vectors,

in which, in the (a) step, the purpose for which the user used the item in the past is inferred, using the latent information instead of the relational data and the purpose information, and

in the (b) step, the negative example degree is computed, using the latent information instead of the purpose information.

(Supplementary Note 18)

The computer readable recording medium according to supplementary note 17,

in which, in the (c) step, the matrix is updated after generation of the matrix, using the negative example degree computed in the (b) step, and new latent information is extracted from the updated matrix,

in the (a) step, the purpose is inferred again, using the new latent information, and

in the (b) step, the negative example degree is computed again, using the new latent information.

(Supplementary Note 19)

The computer readable recording medium according to any of supplementary notes 15 to 18, the program further including instructions that cause the computer to carry out:

(d) a step of dividing the relational data into a plurality of segments chronologically,

in which, in the (a) step, the purpose is inferred from the divided relational data and the purpose information, per segment used in the division, and

in the (b) step, the negative example degree is computed, per segment.

(Supplementary Note 20)

The computer readable recording medium according to supplementary note 15 or 16,

in which, in the (a) step, the purpose is inferred from the purpose information and context information that includes information relating to when the item specified by the relational data was used, and

in the (b) step, the item to undergo computation of the negative example degree is selected, based on the context information, and the negative example degree is computed for the selected item.

(Supplementary Note 21)

The computer readable recording medium according to supplementary note 15 or 16, the program further including instructions that cause the computer to carry out:

(e) a step of inferring context information that includes information relating to when the item specified by the relational data was used, based on the relational data and the purpose information,

in which, in the (a) step, the purpose is inferred from the context information and the purpose information, and

in the (b) step, the item to undergo computation of the negative example degree is selected, based on the context information, and the negative example degree is computed for the selected item.

Although the invention of the present application has been described above with reference to example embodiments, the invention is not limited to the above example embodiments. Various modifications apparent to those skilled in the art can be made to the configurations and details of the invention of the present application within the scope of the invention.

### INDUSTRIAL APPLICABILITY

As described above, according to the invention, an improvement in the computational accuracy of the negative example degrees of items can be achieved. The invention is useful in a recommendation system that is used on EC sites, video viewing sites, and the like. Specifically, according to the invention, it becomes possible to analyze the types of users who do not like specific items and the conditions that are least favored, and the invention is thus useful in applications such as product development, marketing, and risk analysis. Also, in the above-mentioned recommendation system, it becomes possible to make recommendations while avoiding negative examples, and it becomes possible for the recommendation system to improve the click through rate and customer satisfaction, without creating feelings of aversion in users toward the recommendation system. Furthermore, because the purpose and context when users used a service can be inferred by the invention, the invention is also useful in applications such as the construction and design of recommendation systems in which purpose and context are taken into consideration.

### LIST OF REFERENCE SIGNS

10 Negative example degree calculation apparatus (first example embodiment)
11 Purpose inference unit
12 Negative example degree computation unit
13 Used item DB
14 Purpose information DB
20 Negative example degree calculation apparatus (second example embodiment)
21 Purpose inference unit
22 Negative example degree computation unit
23 Latent information extraction unit
24 Used item DB
30 Negative example degree calculation apparatus (third example embodiment)
31 Purpose inference unit
32 Negative example degree computation unit
33 Used item DB
34 Purpose information DB
35 Data division unit
40 Negative example degree calculation apparatus (fourth example embodiment)
41 Purpose inference unit
42 Negative example degree computation unit
43 Context information DB
44 Purpose information DB
50 Negative example degree calculation apparatus (fifth example embodiment)
51 Purpose inference unit
52 Negative example degree computation unit
53 Used item DB
54 Purpose information DB
55 Context information inference unit
60 Negative example degree calculation apparatus (sixth example embodiment)
61 Purpose inference unit
62 Negative example degree computation unit
63 Latent information extraction unit
64 Data division unit
65 Used item DB
110 Computer
111 CPU
112 Main memory
113 Storage device
114 Input interface
115 Display controller
116 Data reader/writer
117 Communication interface
118 Input device
119 Display device
120 Recording medium
121 Bus

1. A negative example degree calculation apparatus comprising:
a purpose inference unit configured to infer a purpose for which a user used an item in the past from relational data specifying the item used by the user in the past and purpose information indicating a use purpose of the item by the user; and
a negative example degree computation unit configured to compute a negative example degree indicating a possibility of the item not being selected by the user, based on the inferred purpose and the purpose information.

2. The negative example degree calculation apparatus according to claim 1,
wherein, in a case where a negative example degree is computed for another item other than a specific item:
the purpose inference unit is configured to use the purpose information indicating the use purpose of the specific item by the user, and
the negative example degree computation unit is configured to compute the negative example degree, based on the inferred purpose and purpose information indicating the use purpose of the other item.

3. The negative example degree calculation apparatus according to claim 1, further comprising:
a latent information extraction unit configured to generate a matrix specifying the item used by the user from the user and the item that are included in the relational data, and to derive a vector representing a preference of the user and a vector representing a latent attribute of the item from the generated matrix, and extract latent information from the derived vectors,
wherein the purpose inference unit is configured to infer the purpose for which the user used the item in the past, using the latent information instead of the relational data and the purpose information, and
the negative example degree computation unit is configured to compute the negative example degree, using the latent information instead of the purpose information.

4. The negative example degree calculation apparatus according to claim 3,
wherein the latent information extraction unit is configured to update the matrix after generation of the matrix, using the negative example degree computed by the negative example degree computation unit, and extract new latent information from the updated matrix,
the purpose inference unit is configured to infer the purpose again, using the new latent information, and
the negative example degree computation unit is configured to compute the negative example degree again, using the new latent information.

5. The negative example degree calculation apparatus according to claim 1, further comprising:
a data division unit configured to divide the relational data into a plurality of segments chronologically,
wherein the purpose inference unit is configured to infer the purpose from the divided relational data and the purpose information, per segment used in the division, and
the negative example degree computation unit is configured to compute the negative example degree, per segment.

6. The negative example degree calculation apparatus according to claim 1,
wherein the purpose inference unit is configured to infer the purpose from the purpose information and context information that includes information relating to when the item specified by the relational data was used, and
the negative example degree computation unit is configured to select the item to undergo computation of the negative example degree, based on the context information, and compute the negative example degree for the selected item.

7. The negative example degree calculation apparatus according to claim 1, further comprising:
a context information inference unit configured to infer context information that includes information relating to when the item specified by the relational data was used, based on the relational data and the purpose information,
wherein the purpose inference unit is configured to infer the purpose from the context information and the purpose information, and
the negative example degree computation unit is configured to select the item to undergo computation of the negative example degree, based on the context information, and compute the negative example degree for the selected item.

8. A negative example degree calculation method comprising:
inferring a purpose for which a user used an item in the past from relational data specifying the item used by the user in the past and purpose information indicating a use purpose of the item by the user; and
computing a negative example degree indicating a possibility of the item not being selected by the user, based on the inferred purpose and the purpose information.

9. The negative example degree calculation method according to claim 8,
wherein, in a case where a negative example degree is computed for another item other than a specific item:
the purpose information indicating the use purpose of the specific item by the user is used, and
the negative example degree is computed, based on the inferred purpose and purpose information indicating the use purpose of the other item.

10. The negative example degree calculation method according to claim 8, further comprising:
generating a matrix specifying the item used by the user from the user and the item that are included in the relational data, and of deriving a vector representing a preference of the user and a vector representing a latent attribute of the item from the generated matrix, and extracting latent information from the derived vectors,
wherein, the purpose for which the user used the item in the past is inferred, using the latent information instead of the relational data and the purpose information, and
the negative example degree is computed, using the latent information instead of the purpose information.

11. The negative example degree calculation method according to claim 10,
wherein, the matrix is updated after generation of the matrix, using the negative example degree computed, and new latent information is extracted from the updated matrix,
the purpose is inferred again, using the new latent information, and
in the computing the negative example degree, the negative example degree is computed again, using the new latent information.

12. The negative example degree calculation method according to claim 8, further comprising:
dividing the relational data into a plurality of segments chronologically,
wherein, p, the purpose is inferred from the divided relational data and the purpose information, per segment used in the division, and
the negative example degree is computed, per segment.

13. The negative example degree calculation method according to claim 8,
wherein the purpose is inferred from the purpose information and context information that includes information relating to when the item specified by the relational data was used, and
the item to undergo computation of the negative example degree is selected, based on the context information, and the negative example degree is computed for the selected item.

14. The negative example degree calculation method according to claim 8, further comprising:
inferring context information that includes information relating to when the item specified by the relational data was used, based on the relational data and the purpose information,
wherein, the purpose is inferred from the context information and the purpose information, and
the item to undergo computation of the negative example degree is selected, based on the context information, and the negative example degree is computed for the selected item.

15. A non-transitory computer readable recording medium that includes a program recorded thereon, the program including instructions that cause a computer to carry out:
inferring a purpose for which a user used an item in the past from relational data specifying the item used by the user in the past and purpose information indicating a use purpose of the item by the user; and
computing a negative example degree indicating a possibility of the item not being selected by the user, based on the inferred purpose and the purpose information.

16. The non-transitory computer readable recording medium according to claim 15,
wherein, in a case where a negative example degree is computed for another item other than a specific item:
the purpose information indicating the use purpose of the specific item by the user is used, and
the negative example degree is computed, based on the inferred purpose and purpose information indicating the use purpose of the other item.

17. The non-transitory computer readable recording medium according to claim 15, the program further including instructions that cause the computer to carry out:
generating a matrix specifying the item used by the user from the user and the item that are included in the relational data, and of deriving a vector representing a preference of the user and a vector representing a latent attribute of the item from the generated matrix, and extracting latent information from the derived vectors,
wherein, the purpose for which the user used the item in the past is inferred, using the latent information instead of the relational data and the purpose information, and
the negative example degree is computed, using the latent information instead of the purpose information.

18. The non-transitory computer readable recording medium according to claim 17,
wherein, the matrix is updated after generation of the matrix, using the negative example degree computed, and new latent information is extracted from the updated matrix,
the purpose is inferred again, using the new latent information, and
the negative example degree is computed again, using the new latent information.

19. The non-transitory computer readable recording medium according to claim 15, the program further including instructions that cause the computer to carry out:
dividing the relational data into a plurality of segments chronologically,
wherein, the purpose is inferred from the divided relational data and the purpose information, per segment used in the division, and
the negative example degree is computed, per segment.

20. The non-transitory computer readable recording medium according to claim 15,
wherein, the purpose is inferred from the purpose information and context information that includes information relating to when the item specified by the relational data was used, and
the item to undergo computation of the negative example degree is selected, based on the context information, and the negative example degree is computed for the selected item.

21. (canceled)
